(19) United States
(12) Patent Application Publication
(10) Pub. No.: US 2013/0262241 A1
(43) Pub. Date: Oct. 3, 2013

(54) SYSTEM AND METHOD FOR AUTOMATIC TEMPLATE FULFILLMENTS AND EDITING FOR VARIABLE DATA

(71) Applicant: DRIVEBUYMARKETING, INC., Cary, IL (US)

(72) Inventor: Rob Nelson, Cary, IL (US)

(73) Assignee: DRIVEBUYMARKETING, INC., Cary, IL (US)

(21) Appl. No.: 13/780,554

(22) Filed: Feb. 28, 2013

Related U.S. Application Data
(60) Provisional application No. 61/761,679, filed on Feb. 6, 2013.
(60) Provisional application No. 61/638,299, filed on Apr. 25, 2012.
(60) Provisional application No. 61/604,008, filed on Feb. 28, 2012.

(51) Int. Cl. G06Q 30/02

(52) U.S. Cl. CPC G06Q 30/0276; G06Q 10/087
USPC 705/14.72; 705/28

(57) ABSTRACT

A system and method for advertising or marketing is provided that received vehicle inventory information from a car dealer and allows the dealer to create individualized signage for desired cars. The marketing system allows the dealer to select a sign size and sign template that includes a plurality of fields, some fillable based on the inventory information, some fields fillable by automatically generating data, and some fields that are presented as blank to the dealer for the dealer to edit. A completed listing including the fields designated by the template is used to generate a set of individualized advertising signs that include a QR code. Customer interactions with the QR code are tracked and provided to the dealer's customer relationship management system.

### CROSS-REFERENCE TO RELATED APPLICATIONS

The present application claims the benefit of the following U.S. Provisional Applications, each of which is hereby incorporated by reference in their entirety: No. 61/604,008, filed Feb. 28, 2012, entitled “System and Method for Automatic Template Fulfillment and Editing for Variable Data”; No. 61/638,299, filed Apr. 25, 2012 entitled “System and Method for Automatic Template Fulfillment and Editing for Variable Data”; and No. 61/761,679, filed Feb. 6, 2013 entitled “System and Method for Automatic Template Fulfillment and Editing for Variable Data”

### BACKGROUND OF THE INVENTION

The present invention generally relates to a system and method for advertising. More particularly, the present invention relates to an automated advertising system for generating print and electronic advertising.

Several advertising systems for car dealerships have been attempted in prior art. These advertising systems may include signs, writing on the car, print, and electronic advertising. However, prior art advertising or marketing system often provided mixed results with dealers complaining that the advertising methods were cumbersome and/or difficult to implement or track. Prior art vehicle advertising systems typically provided very limited ability for individual signage to be individualized to a specific vehicle while still providing useful information to a customer.

### BRIEF SUMMARY OF THE INVENTION

One or more embodiments of the present invention provide a marketing system that receives vehicle inventory information from a dealer. The dealer may then access the marketing system to generate signs that are individualized to specific vehicles. To generate the signs, the dealer first chooses a sign size and is then presented with a set of templates from which to choose. Each template is associated with certain predetermined data fields for each vehicle. Some of the data fields are filled with vehicle inventory information received from the dealer, some of the remaining fields are filled with information that is automatically generated by the marketing system, some of the fields may be fillable with dealer-specific information such as a dealer profile.

However, some of the fields are not able to be filled from these informational sources and are displayed as blanks to the dealer. The dealer may then fill these fields using any of several methodologies including global fill, drop down menus and manual text entries. Once the dealer has completed data entry, the listing of fields for each vehicle is saved and a used to generate a set of vehicle-individualized signage.

Further, the automatically generated information includes the generation of a microsite and associated QR code for each vehicle. The QR code is displayed on the sign and any customer interaction with the QR code is tracked and available to the dealer. Additionally, the microsite offers information about the vehicle and provides the customer with the opportunity to contact the dealer directly or to share the vehicle information.

### BRIEF DESCRIPTION OF THE DRAWINGS

FIG. 1 illustrates an automated templated print and electronic advertising system according to an embodiment of the invention.

FIG. 2 illustrates a flowchart of a standard-fill method of creating a display sign.

FIG. 3 illustrates an example of a website for providing access to the marketing system.

FIG. 4 illustrates an example of a Log-In page.

FIG. 5 illustrates an example sign size selection page.

FIG. 6 illustrates an example of the display of the customizable templates that may be displayed when the dealer selects the 36 inches by 12 inches sign size.

FIG. 7 illustrates an example of the selected template display and form listing of data fields.

FIG. 8 illustrates a flowchart of an auto-fill method of creating a set of display signs.

FIG. 9 illustrates an example of the basic template display and form listing of data fields for use in the auto-fill process.

FIG. 10 illustrates an example of a variable data listmaker.

FIG. 11 illustrates two entries in an example of Content View.

FIG. 12 illustrates an example of the Library.

FIG. 13 illustrates an example of the Lot Planner.

FIG. 14 illustrates an example of the Stock History.

FIG. 15 illustrates an example of the Event Manager.

FIG. 16 illustrates a description of a vehicle where the dealer has entered “tow hooks” in the Option filter.

FIG. 17 illustrates an example of an active list with highlighted stock numbers.

FIG. 18 illustrates the compare/combine pop-up window.

FIG. 19 illustrates an example of the color-coded results of a comparison.

FIG. 20 illustrates an example of the creation of a new empty record.

FIG. 21 illustrates the active list section of the Featured Pricing/Event template.

FIG. 22 illustrates an example of a drop down menu for modifying the event field.

FIG. 23 illustrates the active list section of a financing template.

FIG. 24 illustrates the active list section of a Message template.

FIG. 25 illustrates the selection of a message from a drop down menu.

FIG. 26 illustrates an initial selection panel for a QR analytics application provided by the marketing system.

FIG. 27 illustrates the visitors analytics selection display and analytics active listing.

FIG. 28 illustrates the Sign Effectiveness/Customer Engagement table.

FIG. 29 illustrates the graphical and chart display of the analytic information

FIG. 30 illustrates an exemplary display result of grouping the QR data by day.

FIG. 31 illustrates an example where QR data is first grouped by stock number and then sub-grouped by date.

FIG. 32 the display of additional details from each scan or view that took place that day.

FIG. 33 illustrates the data grouping available under the Info Requests area.

FIG. 34 illustrates an example of an Info Requests active list.

FIG. 35 illustrates the additional fields that may be displayed by the dealer.

FIG. 36 illustrates the data grouping available under the Vehicle Share area.

FIG. 37 illustrates an example of the Vehicle Share active list.

FIG. 38 illustrates the active list of all inventory that is initially presented in the Sign History area.

FIG. 39 illustrates the Sign History filtering controls.

FIG. 40 illustrates the result of filtering by sold and signed fields.

FIG. 41 illustrates a pop-up window displaying further information about a vehicle.

FIG. 42 illustrates the top of the display and shows a message, a make and model, and a price.

FIG. 43 illustrates the second display screen.

FIG. 44 illustrates the third display screen.

Finally, FIG. 45 illustrates the bottom of the display screen.

FIG. 46 illustrates further configuration options for the microsite.

FIG. 47 illustrates a flowchart 4700 reciting one embodiment of the present method in further detail.

FIG. 48 illustrates an example of a featured event plus two line messaging template and associated active list.

FIG. 49 illustrates an additional example of a template and associated active listing.

FIG. 50 illustrates an another example of a template and associated active listing.

### DETAILED DESCRIPTION OF THE INVENTION

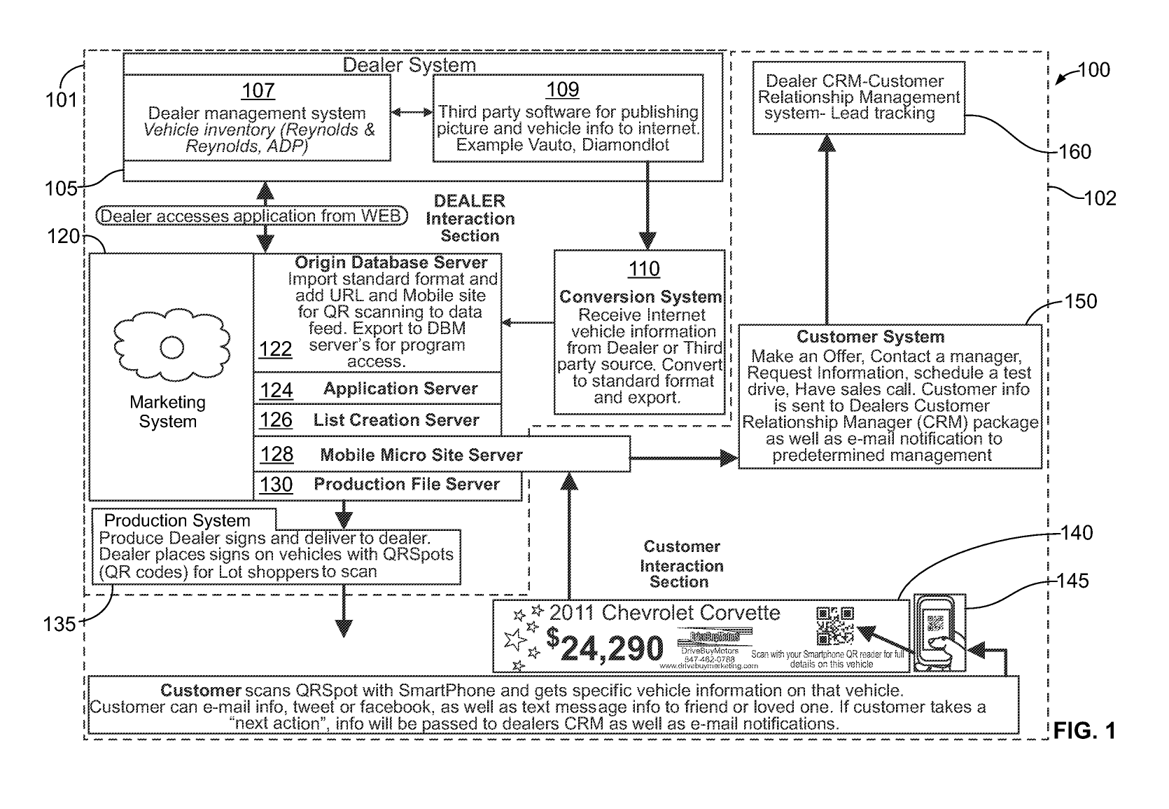

FIG. 1 illustrates an automated templated print and electronic advertising system 100 according to an embodiment of the invention. The automated templated print and electronic advertising system 100 includes a dealer interaction section 101 and a customer interaction section 102. The dealer interaction section 101 includes a dealer system 105 including dealer management system 107 and a software publishing system 109. The dealer interaction section 101 also includes a conversion system 110, a marketing system 120, and a production system 135.

The marketing system 120 includes an origin database server 122, an application server 124, a list creation server 126, a mobile micro site server 128, and a production file server 130.

The customer interaction section 102 includes a display sign 140, a user smartphone 145 (or other device capable of scanning a QR code such as an iPad or other tablet, for example), a customer system 150, and a dealer Customer Relationship Management (CRM) system.

In operation, as further described below, a car dealership has a number of cars in inventory to be sold. As further described below, using the present automated templated print and electronic advertising system 100, the dealer may have signs generated for display on their cars, wherein the signs include a Quick Response (QR) code link to an automatically generated microsite. Customers may use the QR code to gain access to the microsite to request further information on a specific car and all customer interactions with the microsites are provided to the dealer.

More specifically, in operation the dealer management system 107 includes a database of information with regard to each car in the dealer's inventory. For example, the inventory information may be stores in a Reynolds & Reynolds or ADP system of format.

Next, the inventory database is then passed to the software publishing system 109 which processes the inventory database in order to reformat the information for publication to the internet. For example, the Vauto or Diamindlot systems may be employed.

The inventory information is then passed from the software publishing system 109 to the conversion system 110. At the conversion system, the inventory information is further converted to a standard format for export to the marketing system 120.

At the marketing system 120, the inventory information is received by the origin database server 122. The origin database server 122 imports the standard format from the conversion system 101 creates a microsite for each inventory entry in the inventory information.

More specifically, for each car in the inventory information, a microsite is created and a QR code is associated with the microsite. For example, within a site administrated by the marketing system 120, the origin database server 122 may create a series of URL addresses and for each URL address generate or create a one or more pages with (or create a link to) data representing information regarding the associated car. The pages may also include standard controls for interacting with the information, interacting with the dealership, requesting more information, and/or requesting a sales call, for example. The origin database server 122 then creates a QR code to direct a device scanning the QR code to the URL of each microsite.

As further described below, the import of inventory information is typically associated with the date of its importation, so dealers may later compare a spreadsheet database entry from a first date with a spreadsheet database entry from a later date to determine which cars have sold in the intervening time.

Next, at the application server 124, the dealer may interact to select sign size and layout for display on the vehicles.

Once the dealer has used the application server 124 to select the desired template, that information is passed to the list creation server 126. At the list creation server 126 the dealer may select a subset of cars in the inventory to generate signs for (a process typically referred to as “signing” which results in cars that are “signed”), and may modify the signs to be generated. The new composite list is saved and applied to the previously selected template in application server 124 to create and preview the finished signs.

The marketing system 120 compiles the information with regard to desired cars, desired signs, and their associated microsites and QR codes into a standardized spreadsheet database entry that is stored at the marketing system 120.

Additionally, entries are made in the database at the marketing system 120 to indicate which cars are being signed, the date at which they are being signed, and the sign information and type, so that these database entries may be used for tracking the performance of the signing effort.

The list created by the list creation server 126 is then passed to the mobile micro site server which serves the microsites for each of the cars identified in the list. Alternatively, if the microsites have not yet been created, the mobile micro site server 126 may create the microsites and/or QR codes.

The list created by the list creation server 126 is also passed to the production file server 130. The production file server 130 generates production files for the printing of the signs in the list, such as high-resolution .pdf files, for example.

Next, the production files are passed from the production file server 130 to the production system 135. At the production system 130, the production files are used to generate the desired display signs 140. For example, a received high-resolution .pdf file may be printed onto a sign having a peelable, adhesive backing.

The display signs 140 are then shipped to the dealer and placed on the inventory by the dealer. The display signs 140 are now ready for interaction with the customer by the customer's scanning of the QR code on the display sign 140.

Thus, at some later point, the customer proceeds to use a user device such as a smartphone 145 to scan the QR code on the display sign 140. The scanned QR code directs the internet browser on the user device to a microsites that is served by the mobile micro site server 128 and includes information with regard to the car which is referred to on the display sign 140.

As the microsite associated with the display sign, in addition to information about the car being displayed, the customer system 150 allows a customer to do any of the following: Make an Offer, Contact a manager, Request Information, schedule a test drive, and/or Have sales call. Additionally, the customer system 150 records all customer interactions with the microsite and provides records of the customer interactions to the dealer CRM 160. Additionally, an e-mail notification may be sent to predetermined management at the dealer. Also, a record of the customer interactions may be stored on the marketing system 120 for later reference.

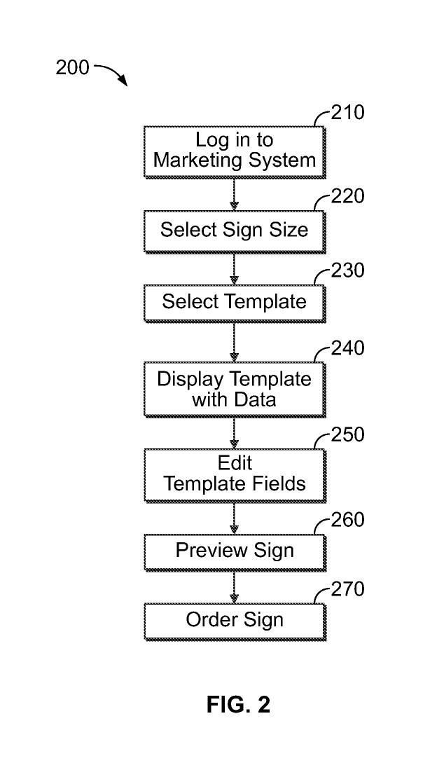

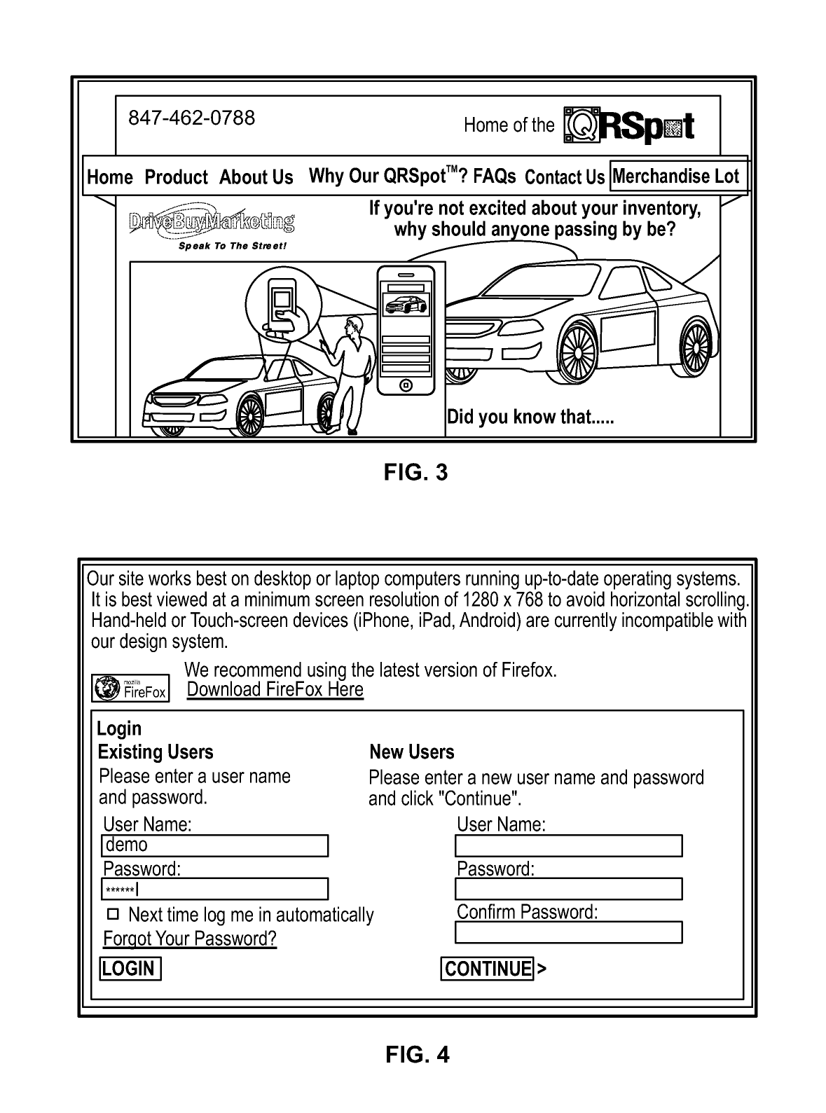

FIG. 2 illustrates a flowchart 200 of a standard-fill method of creating a display sign 140. First, at step 210, the dealer logs into the marketing system 120. For example, the dealer may navigate a browser to a website, such as DriveBuyMarketing.com. At the website, the dealer may select Merchandise Lot from the top navigation bar to be brought to a Log-In page. FIG. 3 illustrates an example of a website for providing access to the marketing system 120.

At the Log-In page, the dealer may log in using a username and password. FIG. 4 illustrates an example of a Log-In page.

Next, at step 220, the dealer selects a desired sign size. Sign sizes include 36 inches by 12 inches, 36 inches by 6 inches, 18 inches by 12 inches, 8.5 inches by 11 inches, and 9 inches by 6 inches. Additionally, other sizes may be provides and signs may be sized in centimeters instead.

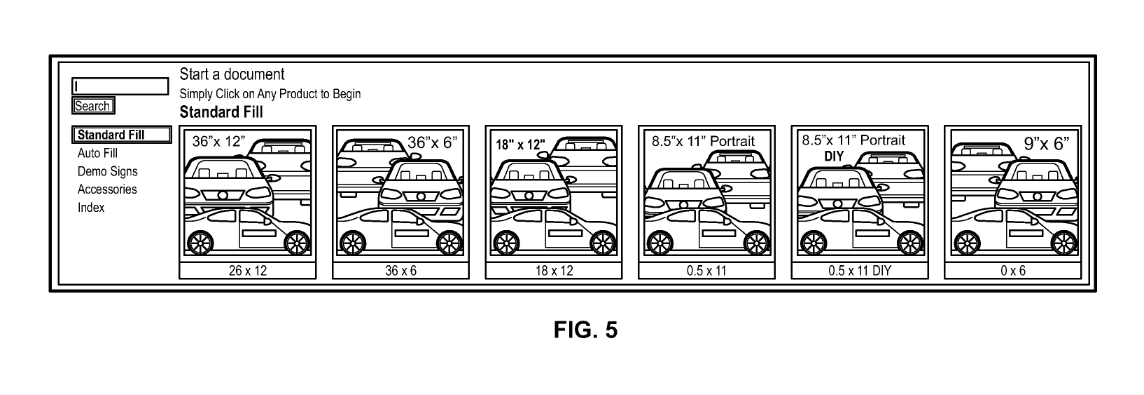

FIG. 5 illustrates an example sign size selection page. The dealer may click on a sign size to select it.

Next, at step 230, templates associated with the selected sign size are displayed and the dealer may select one of the identified templates. The different templates may include different sets of information. For example, templates may include

one or more of: price, dealer contact information, monthly payment, identification of vehicle, financing information, dealership event information, discount information, fuel economy information, was-now pricing information, general sales messages, and images.

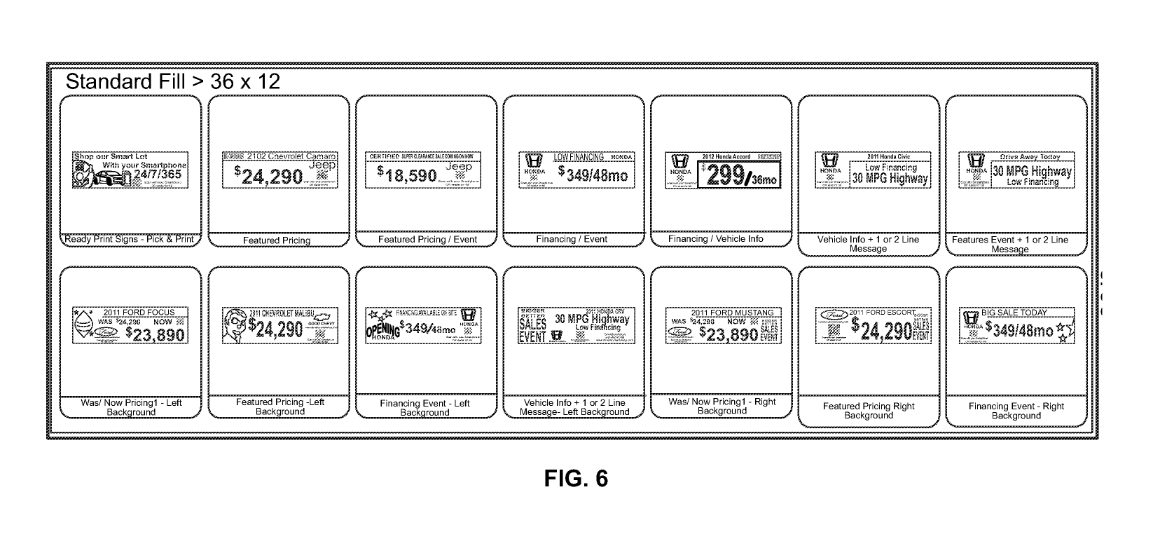

FIG. 6 illustrates an example of the display of the customizable templates that may be displayed when the dealer selects the 36 inches by 12 inches sign size. The dealer may click on one of the templates to select it.

Next at step 240, the template selected by the dealer is displayed. Additionally, a form is displayed listing the data in fields that are editable by the dealer.

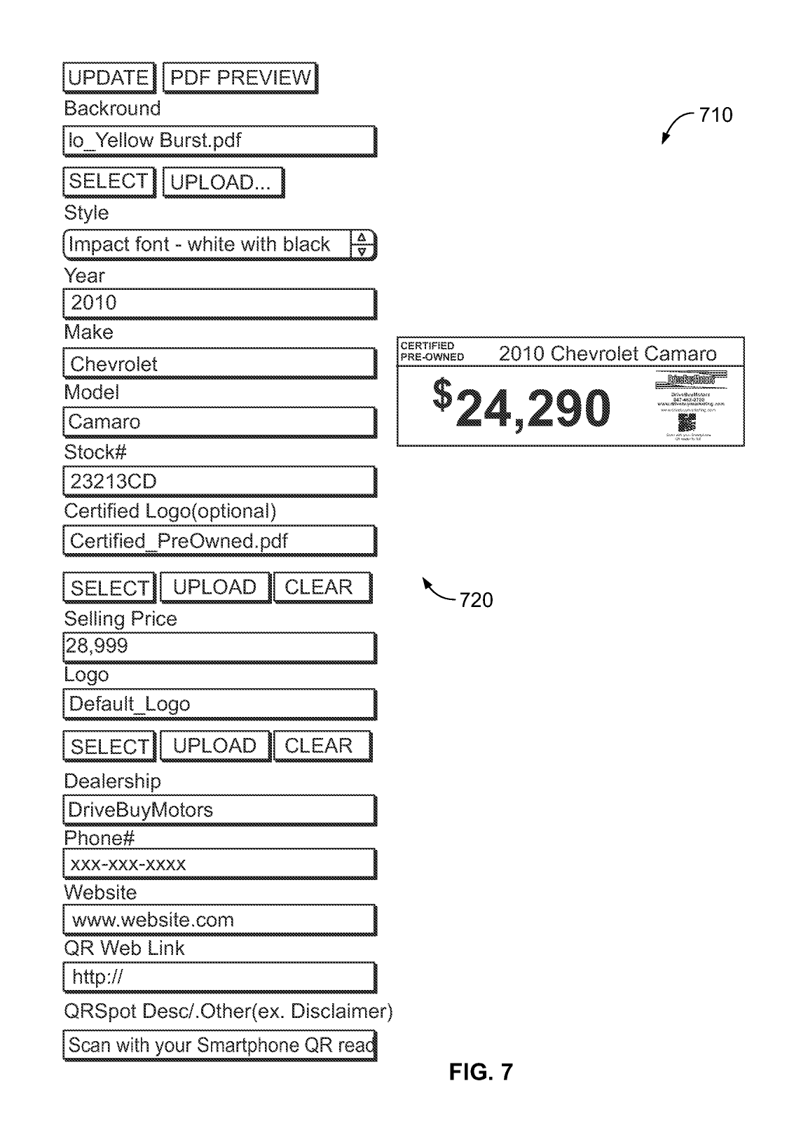

FIG. 7 illustrates an example of the selected template display 710 and form listing of data fields 720. In the example of FIG. 7, the Featured Pricing template has been selected. As shown in FIG. 7, the listing of data fields includes an update button that updates the display of the selected template to display newly entered data when pressed, a PDF preview button that generates a preview PDF of the template with the data entered when pressed, a selected background, a template style, a Year field, a Make field, a Model Field, a Stock number for the vehicle, the option to add Certified Logo, a selling price field, a dealer logo field, a dealership field, a phone number field, a dealer website field, a QR web link field, and a QRSpot descriptor/Other field.

Then, at step 250, the dealer may edit the fields in the form. For example, the dealer may change the background image by selecting the select button in the form. This brings up a library of images that are available to be selected for use as a background, including standard images and images that may have been previously uploaded by the dealer. Once the background images is selected, the image changes on the preview of the template.

Additionally, the styling of the lettering in the sign may be modified using a drop down menu under the “style” entry in the form. Styles include: white with black outline, red with white outline, red with black outline, blue with white outline, blue with black outline, green with white outline, green with black outline, yellow with white outline, and yellow with black outline.

Additionally, the certified logo that appears in the upper left corner of the template display 710 may be removed by pressing the “clear” button in the form. If the certified logo is removed, the other elements in the top line of the sign (year, make, model) are then centered in the sign.

Additionally, in one embodiment, the dealer's username and password is associated with a dealer account that is set up on the marketing system 120. The dealer account includes a dealer profile what includes the dealer's name, logo, phone number and QR web link. When the dealer logs in, the information from the dealer's profile may be automatically entered in the selected template.

Once the dealer is done editing the sign, the flowchart proceeds to step 260 and the dealer may preview the sign. In the example of FIG. 7, a preview of the sign may be generated by selecting the PDF Preview button at the top of the form 720. The PDF may be displayed as a new tab in the browser or as a downloadable PDF.

When the dealer is satisfied with the sign, the flowchart proceeds to step 270 and the dealer orders the sign. For example, the dealer may click on a “Finish” button, add the sign to a check-out cart, and then place their order. The check-out cart may display order details including other signs that may be in the cart. Additionally, the cart may allow the dealer to change quantity, go back and edit the sign, review the PDF

again, duplicate the sign, delete it, or put the order on hold. Additionally, the cart allows the dealer to select a delivery method.

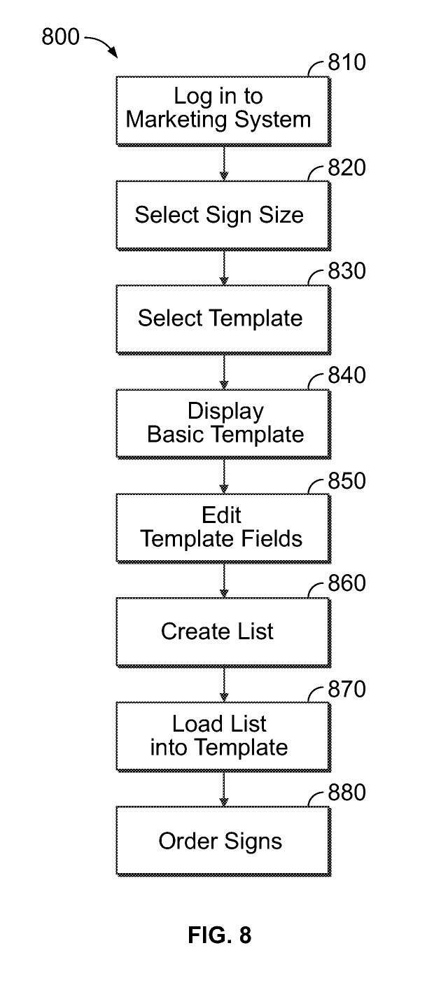

FIG. 8 illustrates a flowchart 800 of an auto-fill method of creating a set of display signs. As opposed to the standard-fill method which generates one sign at a time, in the auto-fill method, the marketing system 200 creates a set of several signs (up to hundreds) at the same time using the dealer's inventory information.

First, at step 810, the dealer logs into the marketing system as described above in FIG. 2. Next, at steps 820 and 830, the dealer selects the sign size and sign template as described above.

Then, at step 840, a basic template is displayed for the dealer

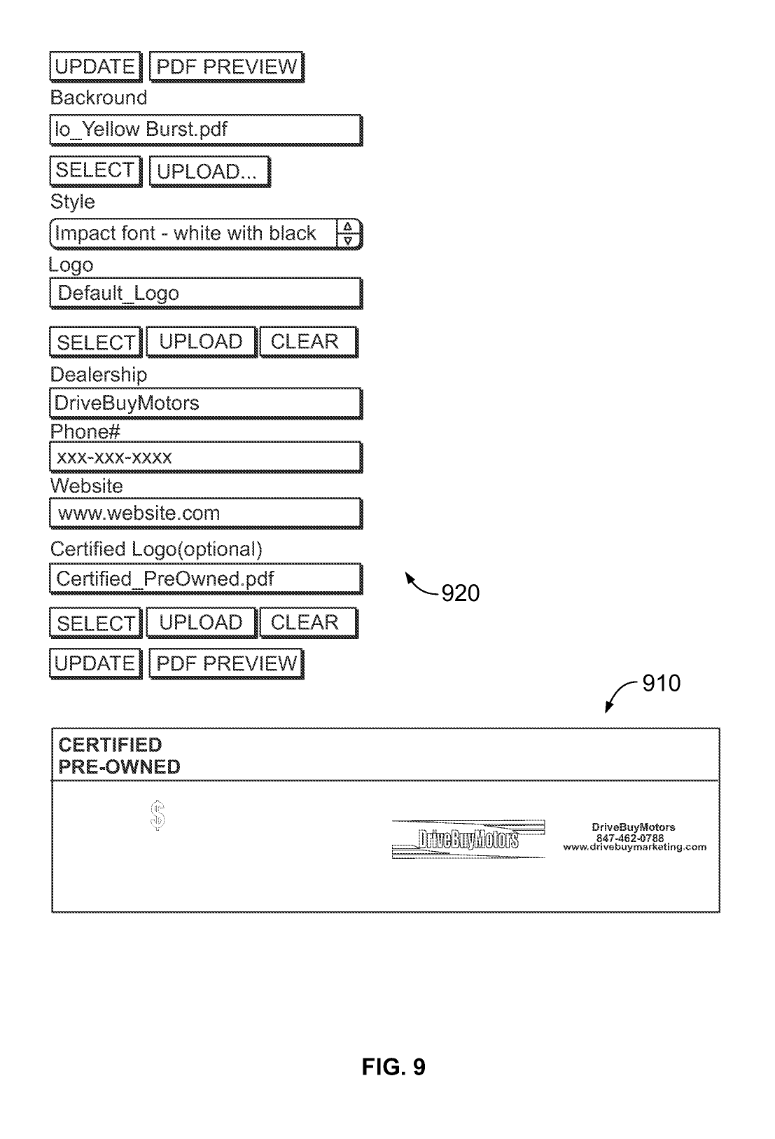

FIG. 9 illustrates an example of the basic template display 910 and form listing of data fields 920 for use in the auto-fill process. As compared to the template in FIG. 7, fewer data fields are available for individual input or displayed on the sign preview. This is because the auto-fill process is designed to create several signs at once with differing vehicle information. Consequently, the basic template display merely displays the sign elements that will be shared among all of the signs being created.

In the example of FIG. 9, the Featured Pricing template has been selected. As shown in FIG. 9, the listing of data fields includes an update button that updates the display of the selected template to display newly entered data when pressed, a PDF preview button that generates a preview PDF of the template with the data entered when pressed, a selected background, a template style, a dealer logo field, a dealership field, a phone number field, a dealer website field, and the option to add a Certified Logo

Next, at step 850, the dealer may edit the fields in the template as discussed above.

Then, at step 860, the dealer creates a listing of signs to be generated. For example, the dealer may click on a “Create List” of “Next Step” button to bring up a listmaker template. The listmaker will be discussed further below. Once the list has been created, it is saved. In one embodiment, the listmaker compares the data base information to what data is required in the template the user selected in step 830. The listmaker then presents the user with a list that is composed of information that was matched in the database as well as supplying field columns for the user's entry of data in fields that are not contained in the database. User may make changes to these field columns by typing in text strings, using pull down menus, or using a global information filler, as discussed further below. The resulting list thus becomes the combination of database information and user input information. The list is then used to populate and produce multiple signs.

The flowchart then proceeds to step 870 where the list is loaded into the template. To load the list into the template, the dealer clicks on a Choose List button and all saved lists are displayed from the Library (discussed below). The dealer then selects one of the lists and the vehicle data from the list is used to automatically generate a sign for each of the vehicles in the list. The signs may be previewed as discussed above.

Next, the flowchart proceeds to step 880 and the signs are ordered similar to as described above with regard to FIG. 2.

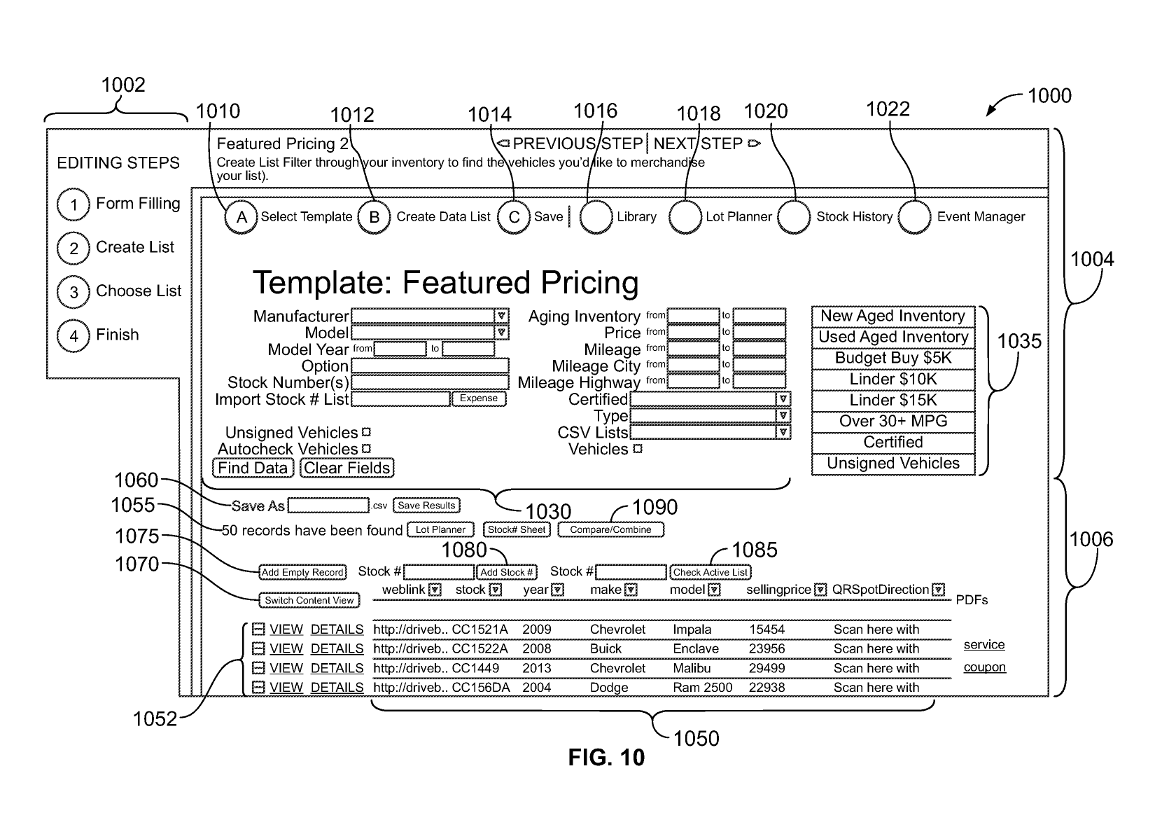

Returning now to the process for making the listing of signs to be generated, FIG. 10 illustrates an example of a variable data listmaker 1000. The listmaker 1000 includes an editing steps section 1002, a filtering section 1004, and an active list section 1006. The editing steps section 1002 identifies the current list creation and editing step that is being performed. In the example shown in FIG. 10, the current editing step is Create List.

The filtering section 1004 provides a number of controls for filtering the overall listing of the dealer's inventory into subset of vehicles that the dealer wishes to sign. The Select Template button 1010 allows the dealer to change the template that the dealer is using. Switching from one template to another may alter the data that is being pulled from the dealer's inventory feed. Additionally, switching from one template to another may change the available field columns as further discussed herein. The current Featured Pricing template pulls vehicle information and selling prices from the dealer's inventory feed. In one embodiment, the template may be selected automatically based on the data available in the dealer's inventory feed.

The Create Data List button 1012 is highlighted because the screen that is displayed is the create data list screen. The Save button 1014 allows the dealer to save the list once the list is complete.

When the Library button 1016 is pressed, a listing of all of the dealer's saved lists and stock lists is shown. The Library allows the dealer to view, load, and download older lists, check stock numbers from old lists, and perform other list operations.

The Lot Planner button 1018 gives the dealer a different view of lists that the dealer has made, which the dealer may print out and use when signing the dealer's vehicles. The dealer may load, view and print current or old lists that the dealer made into the Lot Planner.

The Stock History 1020 allows the dealer to view the dealer's inventory by stock number, showing the dealer which vehicles have had signs made for them, when those signs were made, and even when that car left the lot. The dealer may use this feature to see how effective the dealer's signs are for the dealer's lot. For example, the dealer may compare the “Signed Date” with the “Removed Date” to see how many days it took for that sign to sell the vehicle.

The Event Manager 1022 allows the dealer to add, edit, or delete the dealer's dealerships events or other messages. The events or other messages may be selectable from a pull-down selection for fields that are not supplied by the database. The Event Manager includes the standard event list with hundreds of event sayings to choose from and the dealer may enter their own events. The event manager may also be known as the list manager.

The filtering section 1004 also includes several inventory selection filters 1030. The inventory selection filters 1030 may be used to parse through the dealer's inventory to find the vehicles the dealer wants to merchandise with signs. Individual filters may be entered by a dealer such as mileage from 20,000 to 50,000 and then the Find Data button may be pressed. The system will then review all of the dealer's inventory information and only return vehicles with the indicated mileage. Filters may be deselected by using the Clear Fields button. Preferably, when no filters are selected, only the first 50 records in the dealer's inventory feed are displayed.

Additionally, the inventory selection filters include a filter to select vehicles that have an associated autocheck and/or carfax as shown. Thus, when the autocheck or carfax checkboxes are checked, only vehicles having a VIN for which an autofax or carfax are available are displayed.

The filtering section 1004 also includes quick-list filters 1035. The quick-list filters 1035 are commonly used filters that may allow the dealer to quickly parse through their inventory to either give the dealer a completed list, or at least get the dealer started on the dealer's list making. The quick-list filters include: “New Aged Inventory”, “Used Aged Inventory”, Budget Buy Under $6K?, “Under $10K”, “Under $15K”, “Over 30 MPG”, “Certified”, and “Unsigned Vehicles”.

Turning now to the active list section 1006, the active list section includes active list records 1050. The active list records 1050 show each of the currently selected vehicles as a row and include columns identifying for each vehicle the web site link, stock number, year, make, model, selling price, and QRSpot direction/message. The active list records may also show non-database supplied fields that are part of the template and have been associated with a vehicle, such as a dealer event or message. The dealer may make changes in any of the auto-populated fields in the active list records 1050 by clicking inside of it, deleting the text and entering the new text.

Each of the active records include a View button, a Details button, and a Remove button 1052. Pressing the View button gives the dealer a preview of what a customer sees when they scan the QR code associated with the vehicle. The information may include: photos, details, next-action items, and other information. The Details button gives the dealer the full details of the vehicle which may include a full listing of options and features of the vehicle. The Remove button removes the particular vehicle from the active list.

The active list section 1006 also identifies the number of records 1055 in the current active list. Further, the current active list may be saved by the dealer by clicking the Save As button and entering an identifier.

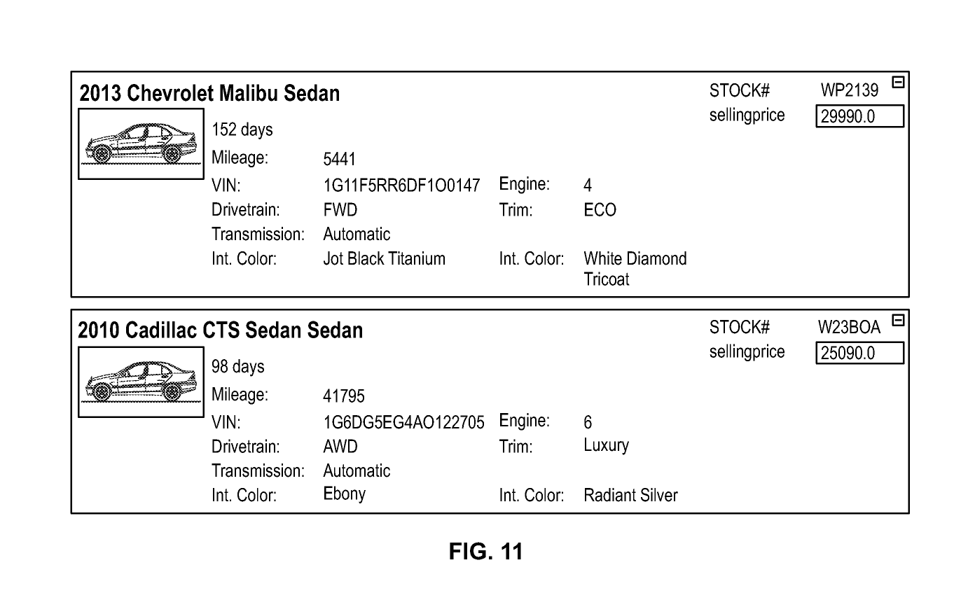

The active list section 1006 allows the dealer to switch to Content View. FIG. 11 illustrates two entries in an example of Content View. The Content View may be more appealing to the dealer and fields that are edited when in Content View are changed in the active list. Vehicles may be removed from the active list while in Content View by selecting the minus button on the far right of the record.

Additionally, as further described below, the Add Empty Record button may be used to add an empty record to the active list records. The dealer may then enter any desired information into the empty record. The empty record is displayed as a row of blank entries at the top of the list of active records

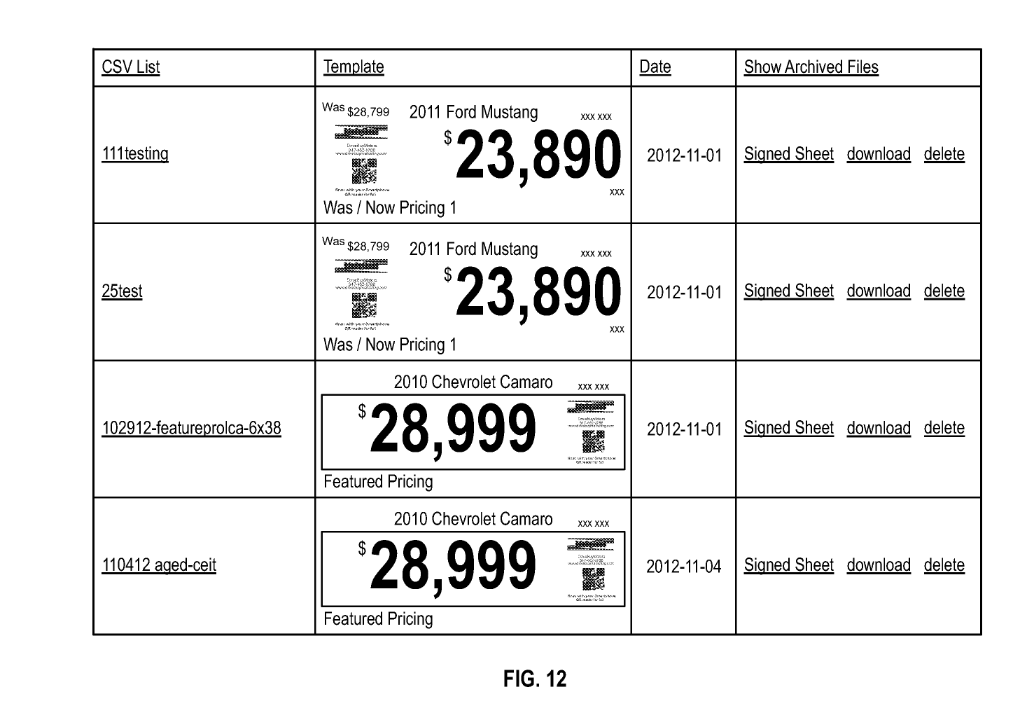

FIG. 12 illustrates an example of the Library. In FIG. 12, clicking on the top of a column heading allows the dealer to sort by that parameter. For example, the dealer may click on “CSV List” to sort by name, “Template” to sort by template name, and “Date” to sort by date saved. Clicking on “Signed Sheet” provides the dealer with a printable sheet of stock numbers that were included in that list. This may be useful in making sure all of the vehicles the dealer ordered signs for get signed. Additionally, the dealer may download each of the lists, for example as a .csv (Comma Separated Values) file, which may be loaded and edited in Microsoft Excel or other spreadsheet programs. Clicking “Delete” erases the list from the dealer's library.

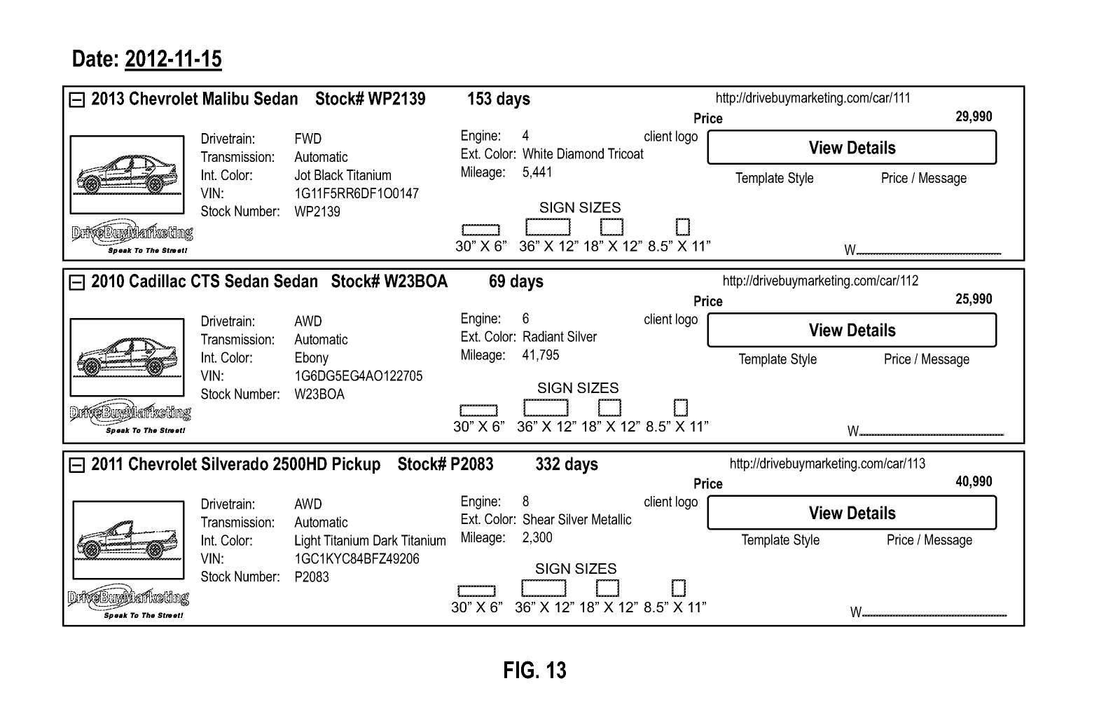

FIG. 13 illustrates an example of the Lot Planner. The Lot Planner may initially look similar to the Content View, but the Lot Planner provides additional options and/or selections, for example for size and template style. The Lot Planner may be used when the dealer has a list of vehicles selected to sign, but the dealer wishes to vary the signage between one or more of the vehicles.

The Lot Planner generates a detailed content view for all the vehicles in the list, but includes selections for the dealer to fill out in deciding how the car should be merchandised (for example, Price or message? What size sign? Where on the car should it go?). For example, the dealer may initially generate a list of all of the dealer's used inventory that has been on the lot for 30 days or longer. Then, that list may be sent to the Lot Planner where it may be printed. The dealer may then use the selections on the sheet to detail how the dealer wants to merchandise each vehicle before creating the signs. The selections may include sign size, template style, and price/message.

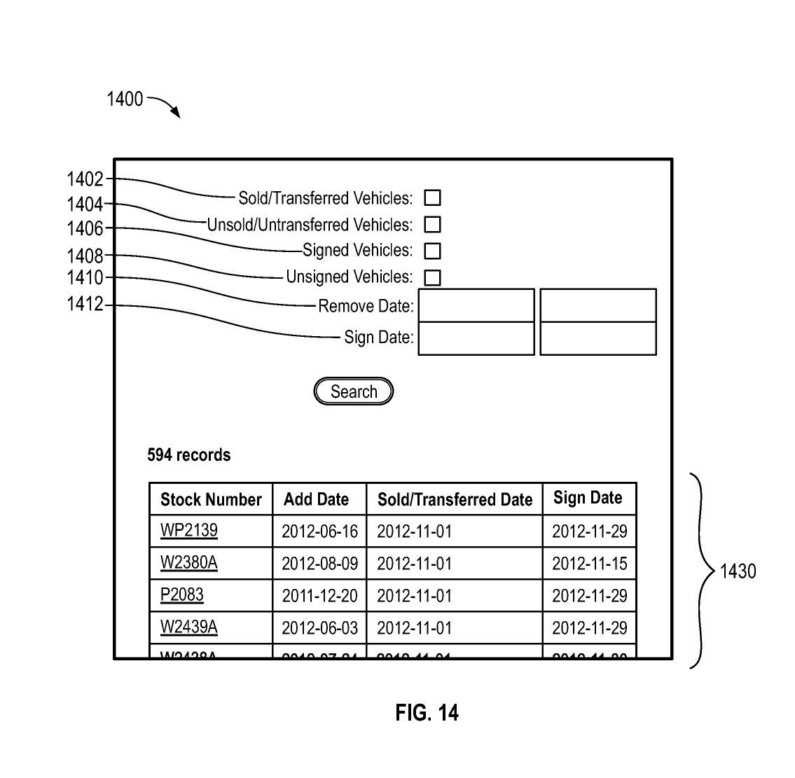

FIG. 14 illustrates an example of the Stock History 1400. The Stock History 1400 provides the dealer with the ability to determine the effectiveness of the dealer's vehicle signage by viewing and comparing which vehicles have been signed and sold with those that have not been signed and not sold. The Stock History 1400 includes a sold/transferred vehicle filter 1402, an unsold/untransferred vehicle filter 1404, a signed vehicles filter 1406, an unsigned vehicles filter 1408, a remove date filter 1410, and a sign date filter 1412.

Additionally, the Stock History 1400 includes an active record listing 1430. The active record listing 1430 includes columns for the each vehicle's stock number, add date (when the vehicle entered the dealer's inventory), Sold/Transferred Date (when it left the dealer's inventory), and Sign Date (the date that an order for a sign was processed by the marketing system).

The active record listing in the Stock History includes all vehicle records that have at any point been associated with the dealer in the marketing system, including previously sold vehicles that are no longer in the dealer's inventory. Using the filters, the dealer may select to view only the sold/transferred or unsold/untransferred, as well as signed or unsigned vehicles.

For example, the dealer may select the sold/transferred vehicle filter 1402, and the signed vehicles filter 1406 to display vehicles that were signed and subsequently sold or transferred.

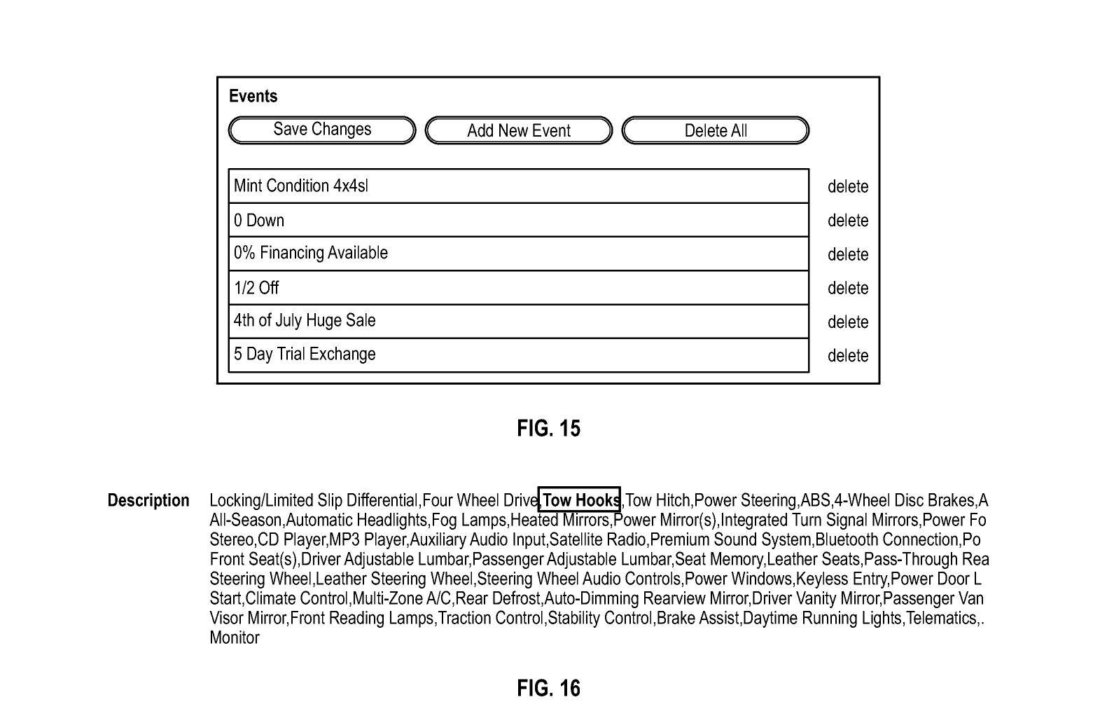

FIG. 15 illustrates an example of the Event Manager 1500. The Event Manager includes many pre-loaded events and/or messages and allows the dealer to modify the non-populated database fields to add an event or to create new events. To edit an event, the dealer may simply click on the field, edit the text, and click “Save Changes”. In one embodiment, the event may be added by the user by using a pull-down menu with many selectable events.

Events may also be deleted if desired. Individual events may be deleted by clicking on the delete button to the right of the event. All events may be deleted by selecting the Delete All button at the top of the display.

We now turn to several examples of using the listmaker of FIG. 10.

As a first example, a dealer may desire a listing of used aged inventory (inventory 90 days or more old) that is also certified. In this case, the initial active list records show all of the dealer's current inventory. These records may be filtered by the dealer my clicking on the Used Aged Inventory quick filter to display only those records that are used aged inventory, and then clicking on the Certified quick filter to further filter the previously returned results. Alternatively, the “Certified” filter may be selected which includes a drop-down menu allowing the dealer to select yes or no. The resulting list may then be saved and is then available in the Library.

As a second example, the initial listing of all of the dealer's current inventory may be filtered by make and model by using the Make and Model drown down menus in the filtering section. Additionally, the Type filter may be used to select all, new, or used.

As a third example, the inventory may be filtered by option. When filtering by option, the dealer enters a text string in the Option filter and the listmaker then proceeds to search the description of each of the vehicles for text matching that string.

FIG. 16 illustrates a description of a vehicle where the dealer has entered “Tow Hooks” in the Option filter.

As a fourth example, the inventory may be filtered by model year of the vehicle. In this regard, the “Model year from/to” filter may be used or the triangle at the top of the year column in the active listing may be clicked to reorder the entries by year.

As a fifth example, the inventory may be filtered by aging. The “Aging Inventory from/to” filter may be used in this regard. Additionally, to find all cars that have entered the inventory in the last 15 days, the dealer may filter by setting the maximum (“to” in “from/to”) to 15 days. This may allow the dealer to identify newly arrived vehicles so that the dealer may immediately place signs on them.

As additional examples, the inventory may be filtered by price and mileage. Additionally, the inventory may be filtered by miles-per-gallon fuel economy as included in the details of each vehicle record. Further, a set of individual stock numbers may be entered and used to filter the inventory, a list of stock numbers may be loaded, or a previously saved list may be used.

Returning again to the listmaker in FIG. 10, the listmaker allows vehicles to be added to the current list by entering the vehicle's stock number in the “Stock #” field and then clicking the “Add Stock #” button 1080. When the new stock number is added, the dealer's inventory is searched for that stock number and the vehicle information associated with the stock number is then added to the current list.

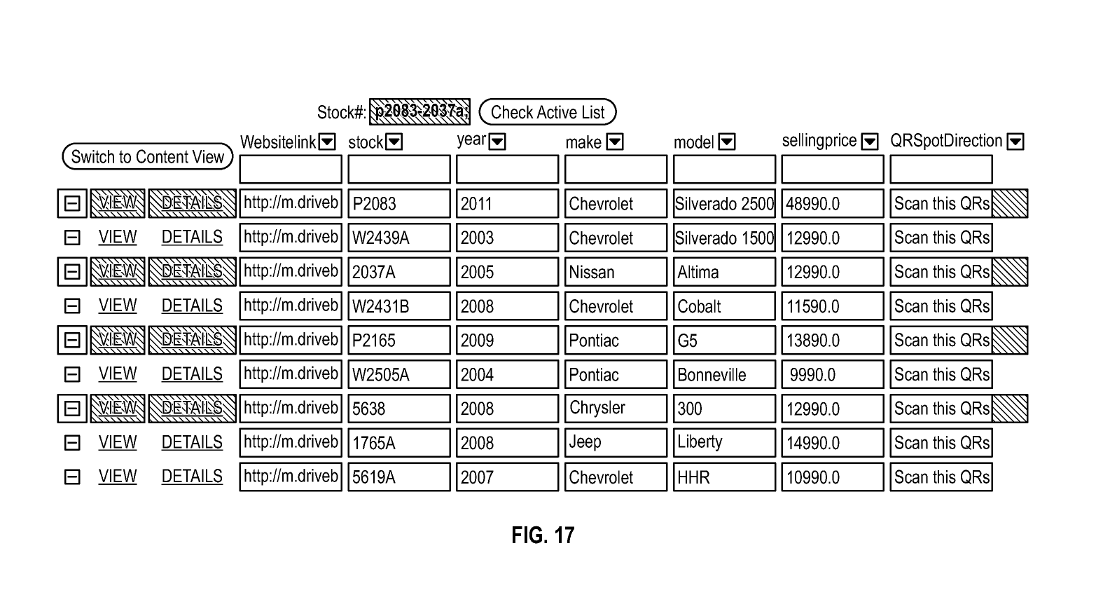

Additionally, the current active list may be searched for a specific stock number by entering the stock number in the “Stock #” field and then clicking the “Check Active List” button 1085. The identified stock number or set of stock numbers is then highlighted in the active list, for example by red. FIG. 17 illustrates an example of an active list with highlighted stock numbers.

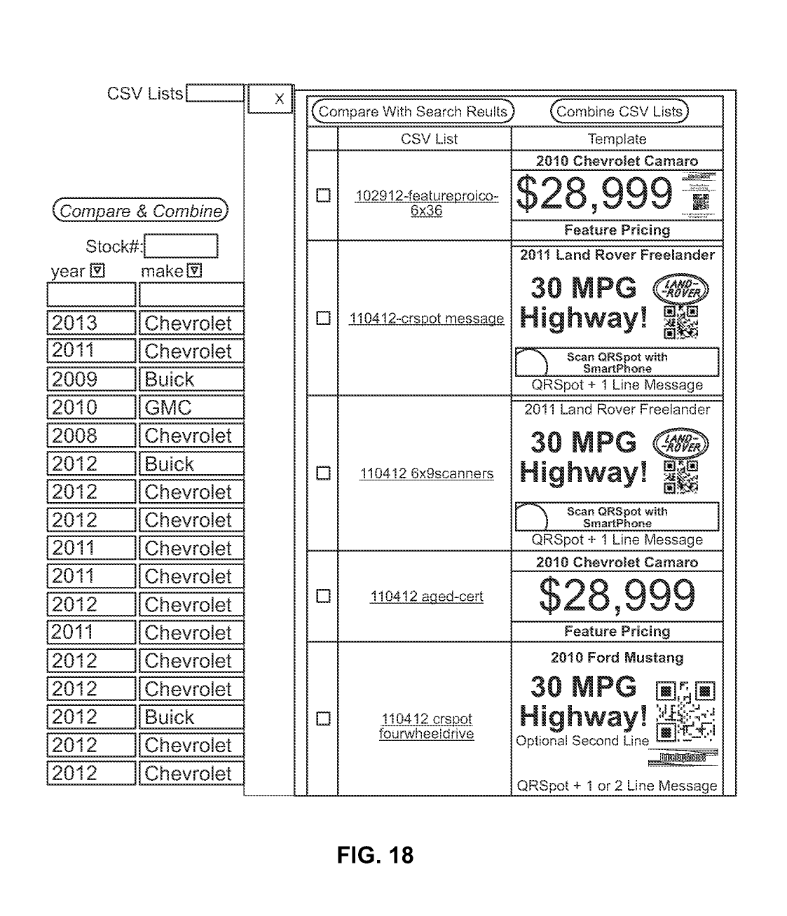

The compare/combine button 1090 allows the dealer to compare the current active list with one or more previously saved lists. For example, the dealer may have a current active list and wish to know which vehicles in the current active list have previously been signed—or have not yet been signed. When the dealer clicks the compare/combine button a pop-up window appears that has thumbnails and names of each of the previously saved lists. FIG. 18 illustrates the compare/combine pop-up window.

In the pop-up window, the checkbox top the left of the entry may be used to select the list. In one example, the dealer may select all of the checkboxes to select all of the lists. The dealer may then click on the “Compare With Search Results” button to compare all of the selected lists with the current active list. As a result, the entries in the current active list are then coded red or green—red for vehicles that appear in a previous list and green for vehicles that do not.

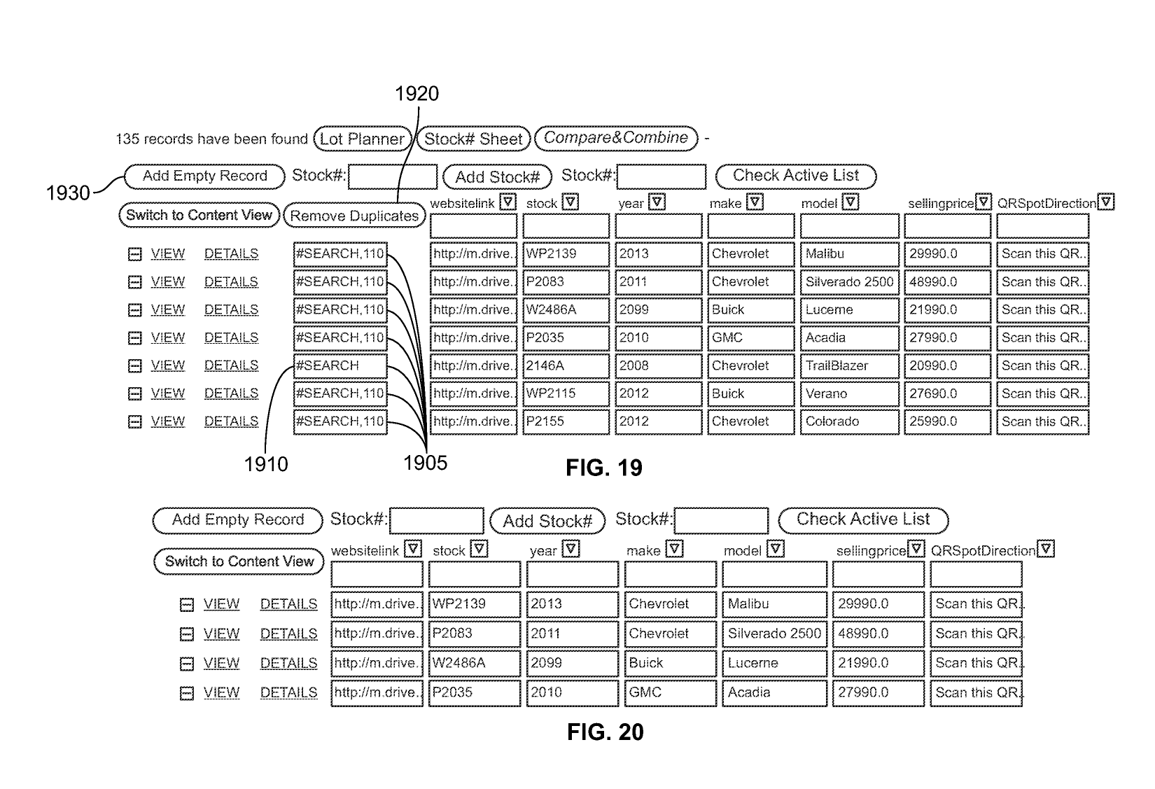

FIG. 19 illustrates an example of the color-coded results of a comparison. FIG. 19 includes several vehicles that were identified as having appeared in at least one previous list 1905, and a vehicle that did not appear in any previous lists 1910. Additionally, by clicking inside of the red bar indicating that the vehicle appeared in at least one previous list, an identification of the previous list in which it appeared is displayed.

Additionally, FIG. 19 includes an Remove Duplicates button 1920 and an Add Empty Record button 1930. Clicking on the Remove Duplicated button 1920 removes from the active list all of the vehicles that are highlighted in red leaving only the green highlighted vehicles that did not appear in of the selected previous listings. Signs may then be generated by the dealer for the remaining vehicles if desired.

With regard to the Add Empty Record button 1930, when clicked, a new blank record appears at the top of the current active listing. The new blank record includes empty fields that the dealer may fill in. FIG. 20 illustrates an example of the creation of a new empty record.

We now return to a discussion of the templates shown in FIG. 6 and selectable at the marketing system. The examples above primarily focused on the Featured Pricing Template, but several other templates are available and provide the dealer with different displays and different dealer-selectable options.

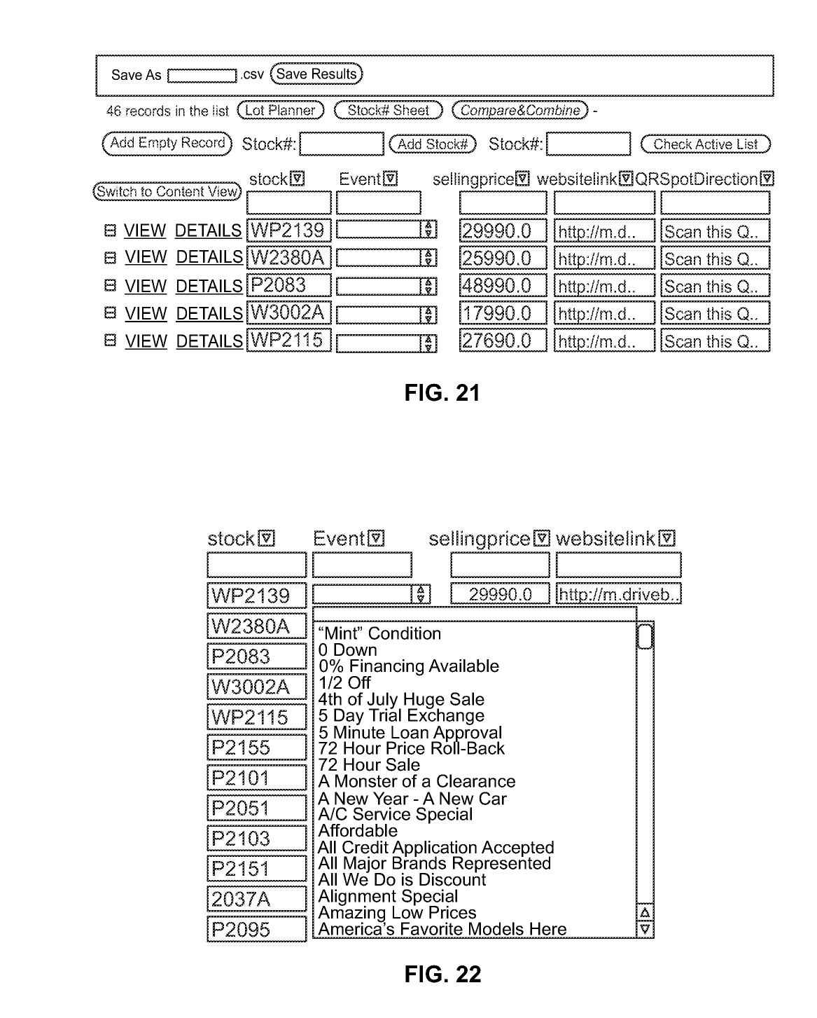

FIG. 21 illustrates the active list section of the Featured Pricing/Event template. The active list section of the Featured Pricing/Event template may be seen to be generally similar to the active list section 1006 of the Featured Pricing Template shown in FIG. 10 with the addition of a column identified as “Event”.

The Event column allows the dealer to enter event information that then appears on the resulting sign. Event information may be entered directly into the event field for each vehicle as a text string or by using a dropdown menu. FIG. 22 illustrates an example of a drop down menu for modifying the event field.

Additionally, if the dealer wants to assign one event text for all of the vehicles, the text may be entered in the blank box just below the “Event” column heading. Once entered, the dealer clicks on the downward pointing arrow to the right of the Event column heading to propagate the event string into the event field of each of the vehicles.

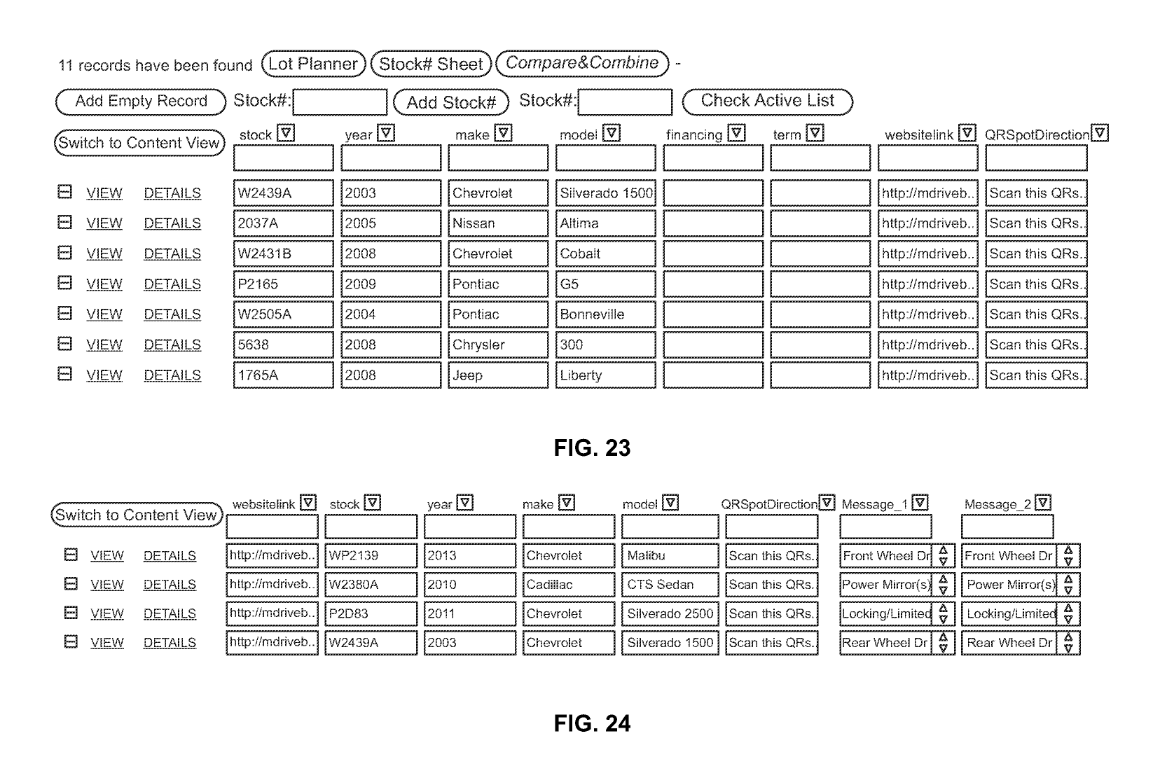

FIG. 23 illustrates the active list section of a financing template. As shown in FIG. 23, active list section of the Financing template may be seen to be generally similar to the active list section 1006 of the Featured Pricing Template shown in FIG. 10 with the addition of two columns identified as “Financing” and “Term”. The operation of the columns is generally similar to that described above in that the dealer may enter data individually into the Financing and Term fields for a specific vehicle, or may enter a text string in the field just below the column identifier and then propagate it to all vehicles. Further, even after propagating the text string to all vehicles, the dealer may then further edit the Financing and Term fields for individual vehicles.

FIG. 24 illustrates the active list section of a Message template.

As shown in FIG. 24, active list section of the Message template may be seen to be generally similar to the active list section 1006 of the Featured Pricing Template shown in FIG. 10 with the addition of one or two columns identified as “Message_1” and “Message_2”. The operation of the columns is generally similar to that described above in that the dealer may enter data individually into the Message_1 and Message_2 for a specific vehicle, or may enter a text string in the field just below the column identifier and then propagate it to all vehicles. Further, even after propagating the text string to all vehicles, the dealer may then further edit the Message_1 and Message_2 fields for individual vehicles.

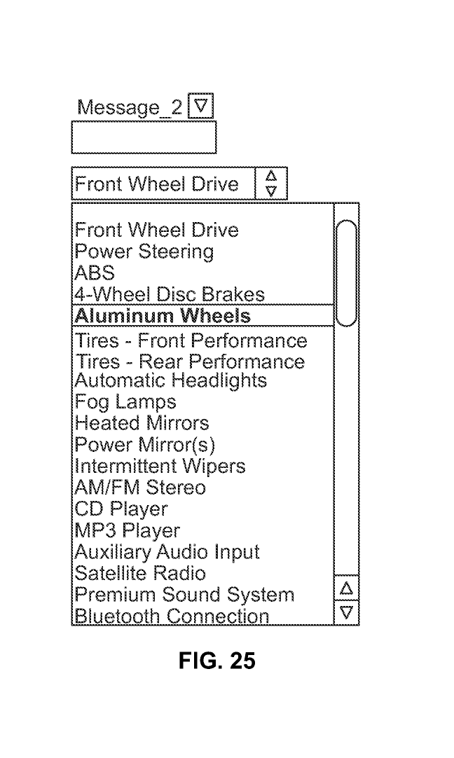

Additionally, the message may be selected from a drop down menu as shown in FIG. 25. Alternatively, the dealer may choose to only enter one of the Message_1 or Message_2 fields and leave the other blank. In this case, the remaining message is automatically re-sized to be larger and take up the space that the two messages would previously have occupied.

Returning now to the automated templated print and electronic advertising system 100 of FIG. 1, it is noted that the customer system 150 provides analytics to the dealer CRM system 160 with regard to the use of the QR codes placed on the signs that are positioned on the vehicles. Alternatively, the QR code usage analytics may be provided to the marketing system 120 for later viewing or retrieval by the dealer.

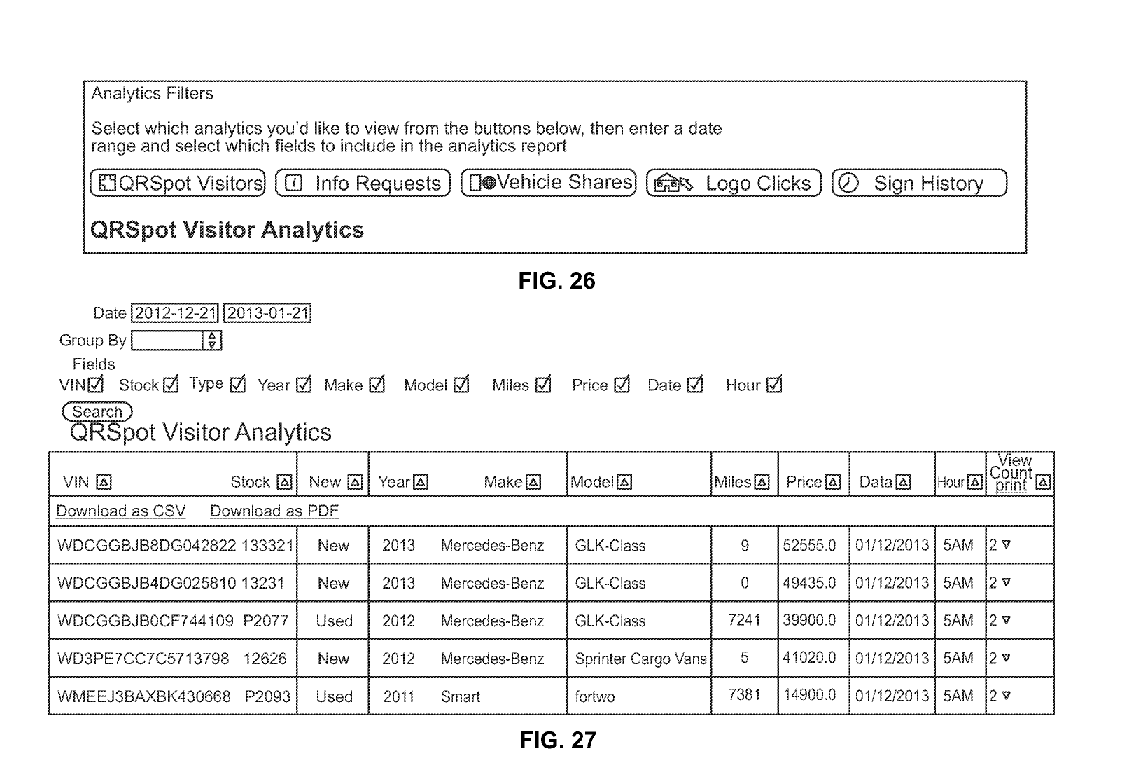

FIG. 26 illustrates an initial selection panel for a QR analytics application provided by the marketing system. The dealer is provided with the options of viewing Visitors, Info Requests, Vehicle Shares, Logo Clicks, and Sign History, each of which will be discussed below.

Visitor Analytics: This is where all scans made and unique page views are tracked. For example, when 1 person scans a QR code on a lot (1 scan/page view), and then walks the lot for a few minutes and scans the same QR code, it is preferably recorded as a single unique page view.

Info Requests: Every time a viewer requests information, makes an offer on a vehicle, schedules a test drive, or contacts a manager directly, these requests are all tracked here, including all of the information that the viewer gave when making the request.

Vehicle Shares: When a viewer e-mails, texts, tweets, or posts a listing of one of the vehicles, it is tracked here including where and how it was shared.

Logo Clicks: The dealership's logo is displayed on every QR page and is clickable by a user to direct the user to the dealer's main site. Every time a user goes from one of the vehicle pages to the dealer's main website, it is recorded here.

Sign History: Provides a complete record of all of the vehicles on the dealer's lot, distinguishing between which have been signed vs. those that have not been signed, sold/transferred vs. not sold/untransferred, as well as dates that track when the car has entered the dealer's inventory and when it left the dealer's inventory.

Filter Page: This bold header underneath the analytics buttons will tell you which analytics you are viewing.

Turning now to the Visitors Analytics, FIG. 27 illustrates the visitors analytics selection display and analytics active listing. The visitors analytics selection display includes a date range selection that is editable by the user and may be configured to display data for the last 30 days as a default.

Additionally, the visitors analytics selection display includes a Group By pick-list. For the pick-list, it is noted that for each QR scan a considerable amount of information is recorded. The information for each scan includes the VIN of the vehicle, the stock number, the type, they year, the make, the model, the number of miles, the price, the date the QR code was scanned and the hour. However, when all the fields are selected and shown at once, it may be overwhelming to a dealer.

For example, in order to view and scrutinize the data and analytics more clearly, the dealer may not want to see every single piece of information tied to a unique scan or view, but instead see only how many total scans or views were made on a single particular vehicle. To do this, the dealer Groups the analytics by either Stock or VIN #—to identify and isolate specific vehicles in the active list. This allows the dealer to see how many total views were made on a single specific vehicle, and then investigate the specifics of the each view by expanding the record within the table.

When the analytics are Grouped by a certain Field, or multiple Fields, the data is compressed and records that have matching Grouped-By values are be combined. However, the dealer is able to expand these combined records to view the individual and unique data of each view that happened within that group. For example, selecting Group By Date combines all scans or views on each individual day, but the dealer may expand on that day to see which particular vehicle got scanned and what time it happened.

The visitors analytics section display also includes field selections. The individual field selections work much the same as the Group By function, but instead of sorting by just one field, the dealer may group the analytics by several fields. For example, by having Date and Hour selected, the system combines records that have matching Date and Hour data (same day, same hour) and group them. The dealer may expand and investigate individual records and information if desired.

The visitors analytics section display also includes a search button that is used to initiate the search, for example after making changes to the checked fields.

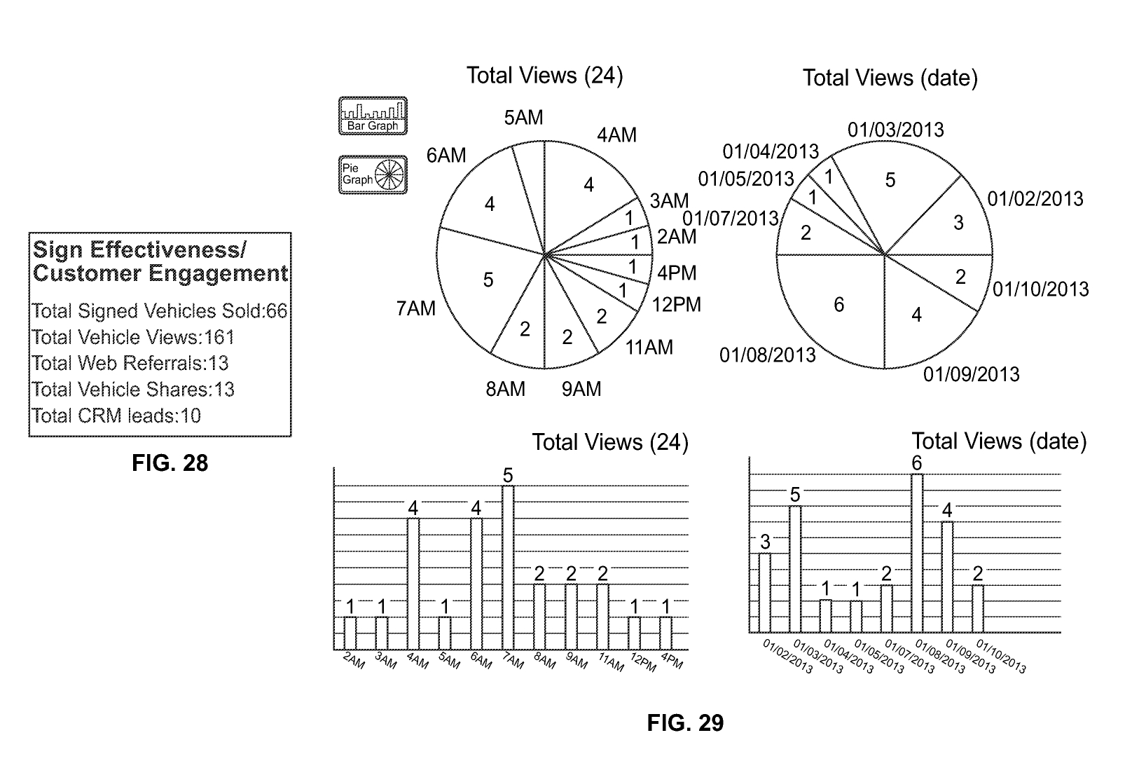

FIG. 28 illustrates the Sign Effectiveness/Customer Engagement table. The dealer is provided with the option to create the table which displays all QR activity at the dealership within a selected date range. The Sign Effectiveness/Customer Engagement table includes the following:

Total Signed Vehicles Sold/Transferred: This field identifies how many vehicles that had been signed were sold/transferred in the identified date range.

Total Vehicle Views (also known as QR Visitors): This field is a total of all scan and page views that occurred within the selected date range.

Total Web Referrals (also known as Logo Clicks): This field is a total of the number of clicks on the dealer's logo that then directs the clicker to the dealer's homepage.

Total Vehicle Shares: This field indicates the number of times that the listing was shared by the person scanning the QR code. For example, the person may share the listing using any of e-mail, texting, Twitter, or Facebook.

Total CRM Leads (also known as Info Requests): This field identifies the number of times that the person scanning the QR code requested more information or activity from the dealer. For example, the person may make an offer, schedule a test drive, get more info, contact a manager directly, or fill out a form for an information request.

In addition to a numeric display of analytics as mentioned herein, the analytics information may be displayed graphically as pie or bar charts as shown in FIG. 29.

Returning to the QR visitor analytics shown in FIG. 27, the initial display of visitor analytics may display all the different and individual pieces of information that are tracked through QR code activation. For the default analytic, the data table at first includes mostly individual records that are displaying all fields of collected information already (vehicle info, price, miles, date, time, etc.). However, using the Group By function and Field selections allows the dealer to consolidate the data tables and sift through the analytics with a much less intimidating data expansion option on only the records you choose.

In the QR visitor analytics shown in FIG. 27, the data table at first displays all of the fields of information picked up by a QR scan or view. However, if the analytics were displaying the Info Request analytics, then more information fields would be displayed such as Request Type (make an offer, request more info, direct manager contact, schedule test drive, etc.), E-mail, and/or Phone number (if a customer enters one themselves). Thus, different analytics display some different types of information or one or more subsets of the QR code activation information that is stored.

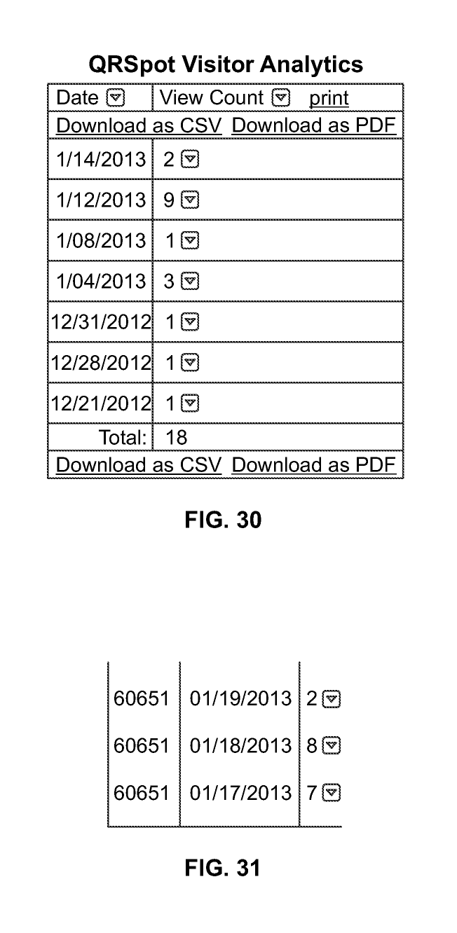

One way of viewing the QR data is to group the QR data by date using the date field and the Group By command. The result is a listing by day of the number of QR records that took place on that day. Preferably, when selecting an option from the Group By menu, the remaining fields are unchecked. FIG. 30 illustrates an exemplary display result of grouping the QR data by day.

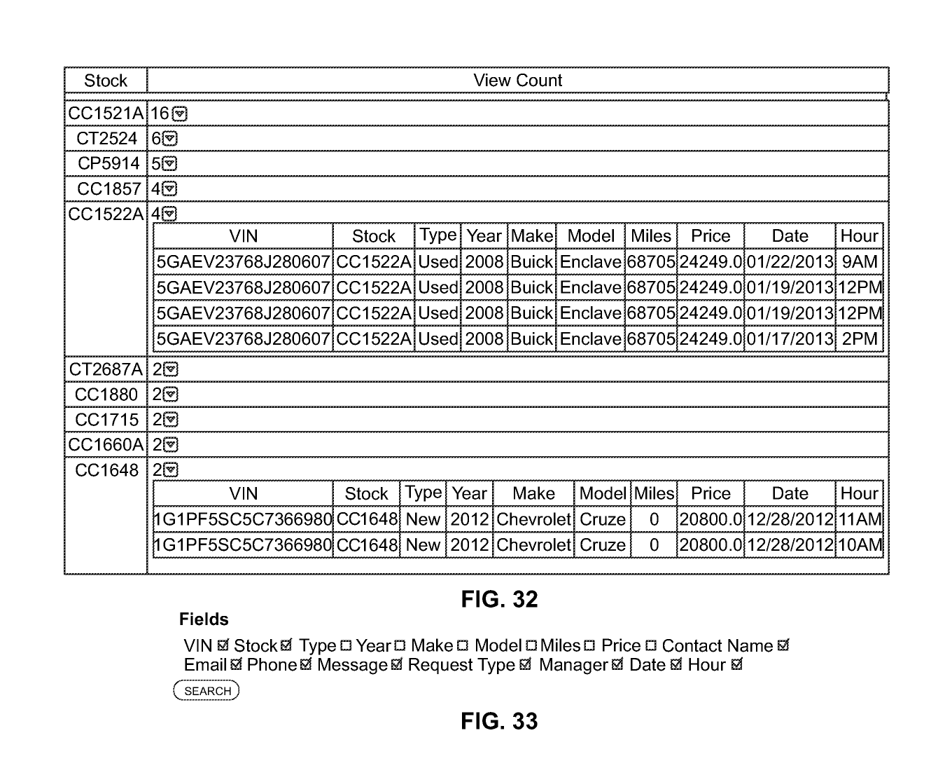

FIG. 30 shows only the date on which QR events were recorded and how many QR events were recorded on the day. Even though the only fields shown in the table are the date and the QR event count, to the right of each date's view count is an arrow. When the arrow is selected, it expands to show the individual events underlying the count. Thus, with the grouped count expanded, the dealer may drill down to see the specific details from each scan or view that took place that day, for example. This is illustrated in FIG. 32.

Similar to the grouping illustrated above by date, the QR date may be grouped by any of the fields identified in FIG. 27. Additionally, the QR data may initially be grouped by a first field, and then sub-grouped by selection of a second field.

FIG. 31 illustrates an example where QR data is first grouped by stock number and then sub-grouped by date. Note that the same stock number appears as two entries—one on each of two different dates—and the number of QR events for each date is displayed.

QR analytics information may also be saved, downloaded, or printed.

Turning now to the Info Requests field of FIG. 26, when the dealer clicks on the link and enters the Info Requests area, the dealer is presented with additional data groupings to choose from as shown in FIG. 33. The additional groupings include: contact name, email, phone, message, request type, and manager.

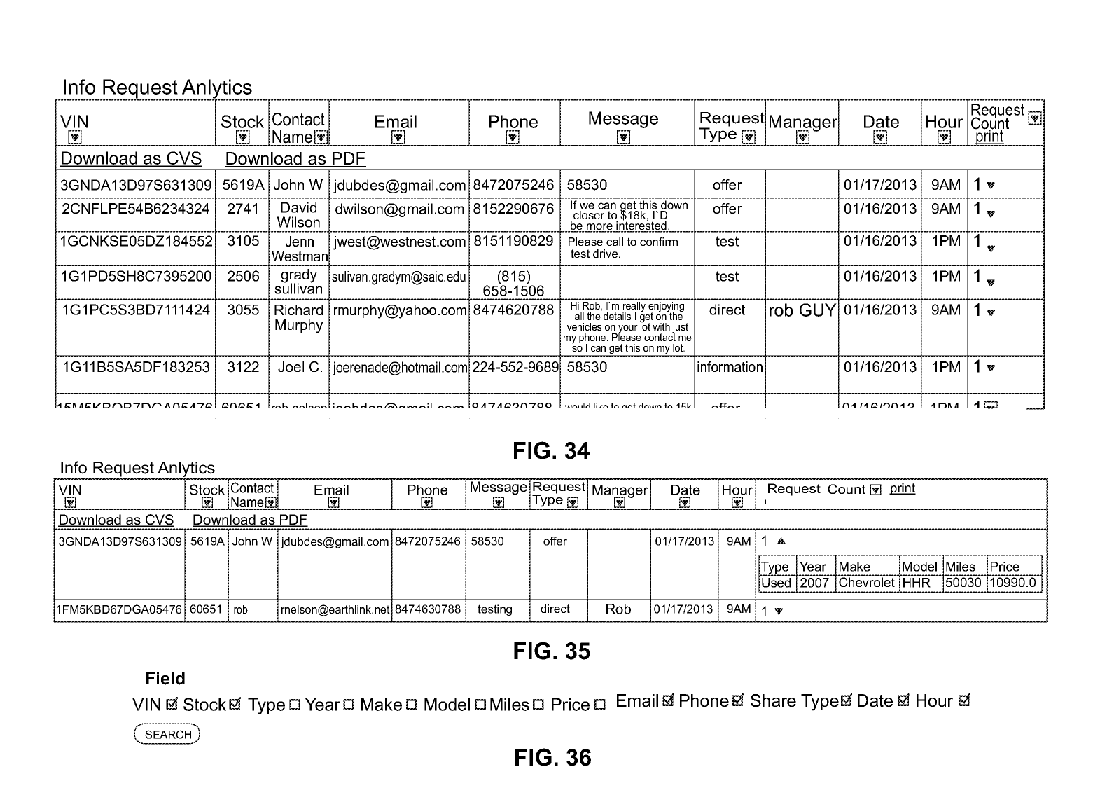

FIG. 34 illustrates an example of an Info Requests active list. For each VIN/Stock number, the fields identified above are displayed as well as a request count. In this way, a dealer may track which vehicles are receiving a number of requests and then immediately see information about the requests. If the dealer wishes to see additional information fields, the down arrow to the right may be used to display the fields, as shown in FIG. 35.

Turning now to the Vehicle Share field of FIG. 26, when the dealer enters the Vehicle Share area, the dealer is presented with additional data groupings to choose from as shown in FIG. 36. The additional groupings include phone and sharetype.

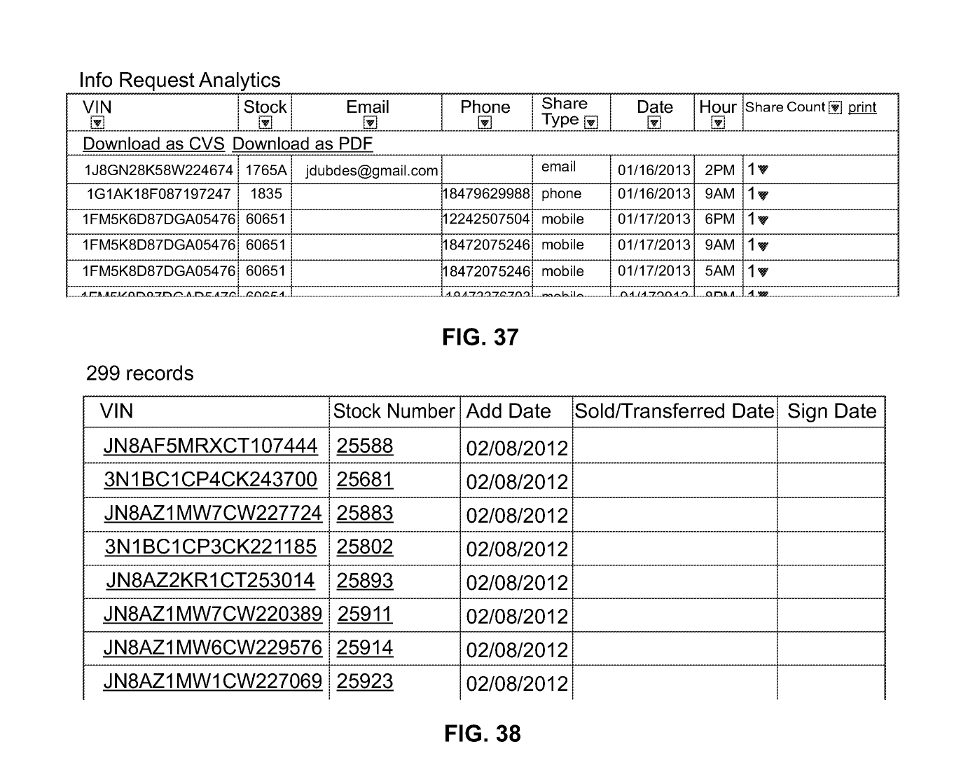

FIG. 37 illustrates an example of the Vehicle Share active list. As shown the share types for the QR events include email, phone, and mobile. Additionally, the e-mail address that received the sharing e-mail is also listed. The fields function similarly to those discussed above.

Turning now to the Sign History field of FIG. 26, when the dealer enters the Sign History area, the dealer is initially presented with an active list of all inventory entries including both sold/transferred and unsold/untransferred and signed and unsigned, as illustrated in FIG. 38.

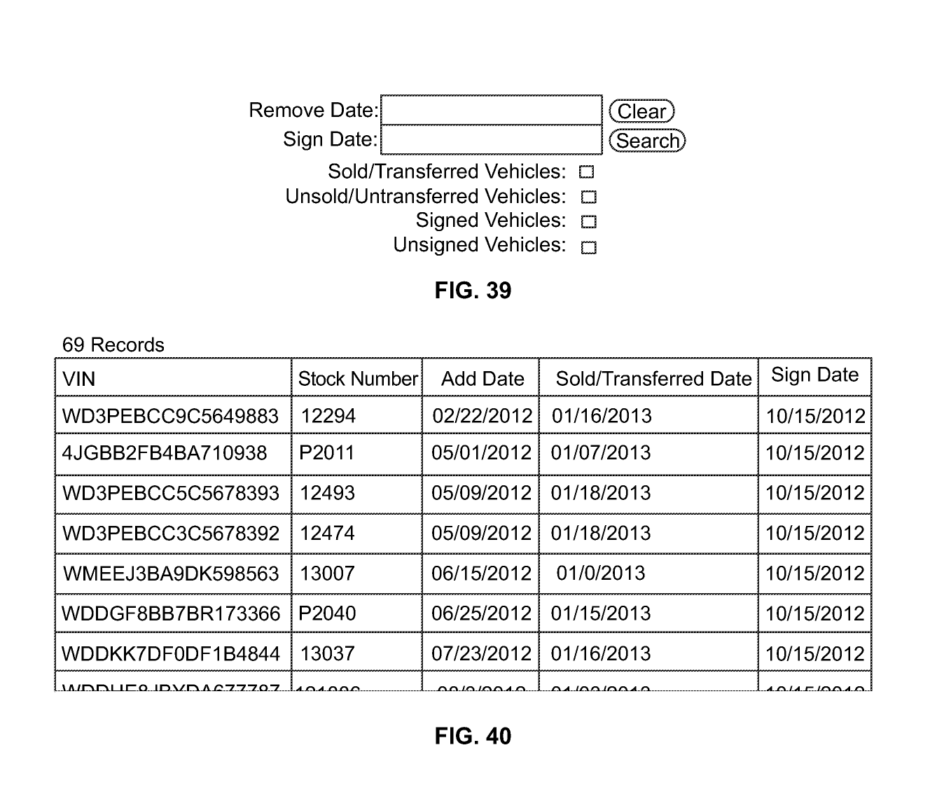

The dealer may then use controls similar to those presented and discussed in FIG. 14 above and as shown in FIG. 39 to filter the list of inventory entries.

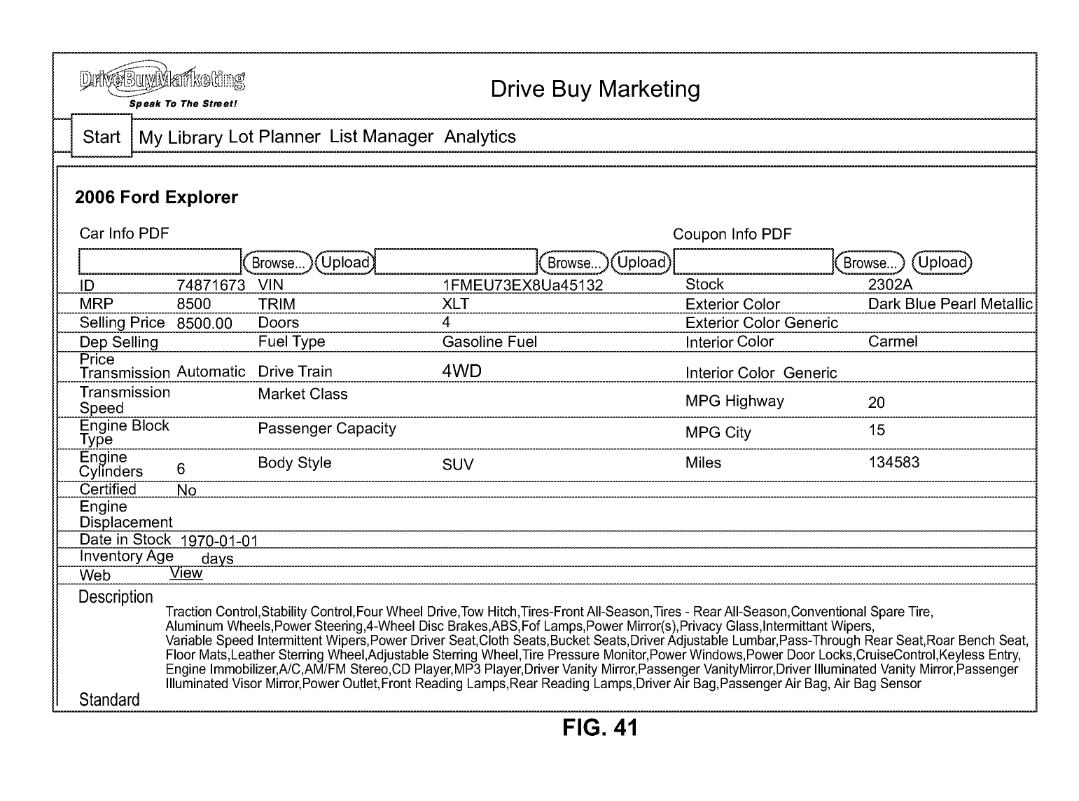

For example, the result of filtering the inventory by sold/transferred vehicle and signed vehicle is shown in FIG. 40. The result identifies the number of returned vehicles in the upper left corner. If the dealer identifies additional information about a specific vehicle, the dealer may click on the VIN or Stock number of the vehicle and an additional window is displayed for the dealer as shown in FIG. 41.

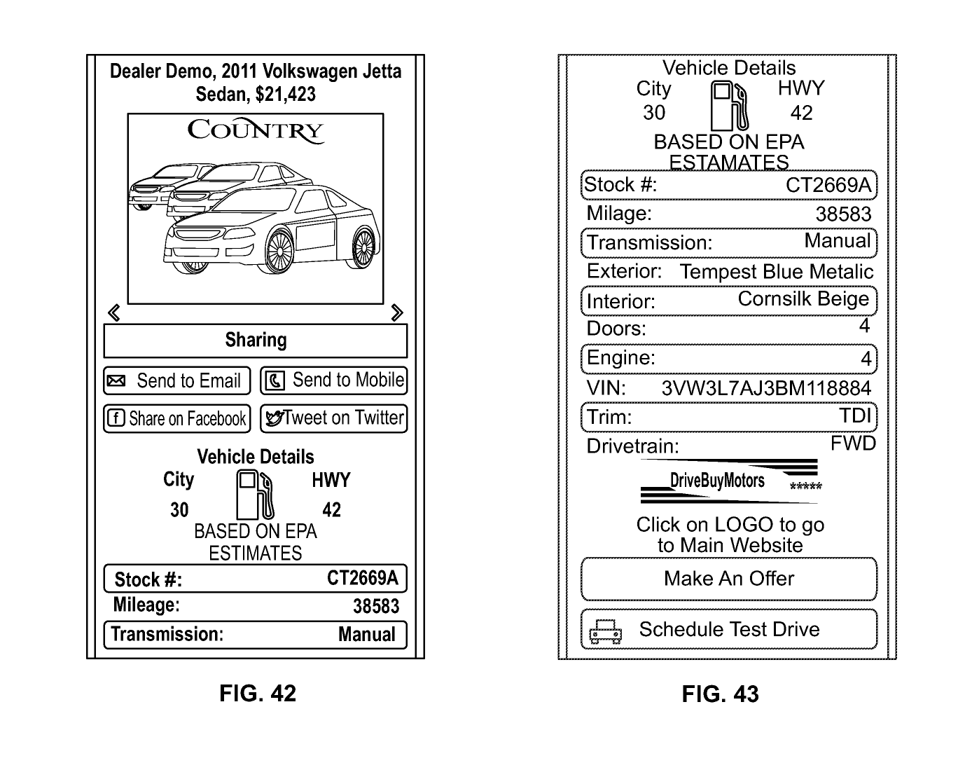

FIGS. 42-44 illustrate screenshots of the display that is provided to a customer smartphone or other QR-reading device when the customer scans a QR code on one of the signs provided above. The screenshots in FIGS. 42-44 are a scrolling display wherein the screenshot of FIG. 42 is normally displayed (depending on the customer's device) and then the customer may scroll downward through the screens shown in FIGS. 42-44.

FIG. 42 illustrates the top of the display and shows a message, a make and model, and a price. Also shown is a picture of the car. Under the picture, several sharing options are provided. As mentioned above, the customer may share the listing using e-mail, on Facebook, on Twitter, or may send the listing to another mobile device.

Underneath the sharing options, vehicle details are provided. The vehicle details include the fuel economy, often expressed in miles or kilometers per gallon, as well as the stock number, mileage, and transmission.

Scrolling downward to the second display screen shown in FIG. 43, the vehicle details continue and include the exterior color, interior color, door, engine, VIN, trim, and drive train. Under the vehicle details is the dealer logo. As discussed above, when a customer clicks or selects the dealer logo, the customer is brought to the dealer's main site.

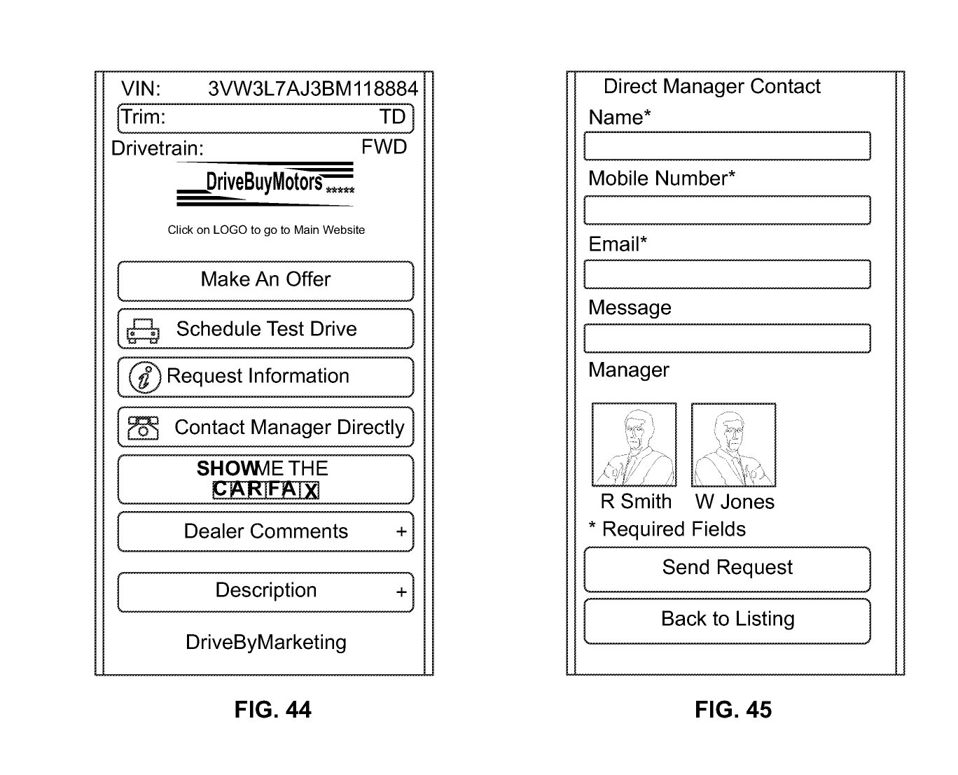

Under the dealer logo are presented the information requests or customer interaction requests. The information requests shown in FIG. 43 allow the customer to make an offer or schedule a test drive and continue in FIG. 44 below.

FIG. 44 illustrates the third display screen. In FIG. 44, the remainder of the information requests are shown including: requesting information from the dealer, contacting the manager directly, providing the carfax, a link to any dealer comments, and a description of the vehicle.

Finally, FIG. 45 illustrates the form that a customer is presented with if they select the “contact manager directly” button as shown above. FIG. 45 includes a direct manager contact that the customer may fill out and send directly to a manager by pressing the Send Request button. Additionally, a picture of the manager or managers may be displayed. Finally, the Back to Listing button may return the customer to the top of the display.

As mentioned above, the display shown in FIGS. 42-44 is provided by data stored on a microsite created as part of the list creation process. The creation process also determines the QR code and associates it with the microsite so that when a customer scans the QR code, the data from the micro site is displayed to the customer as shown in FIGS. 42-44 above.

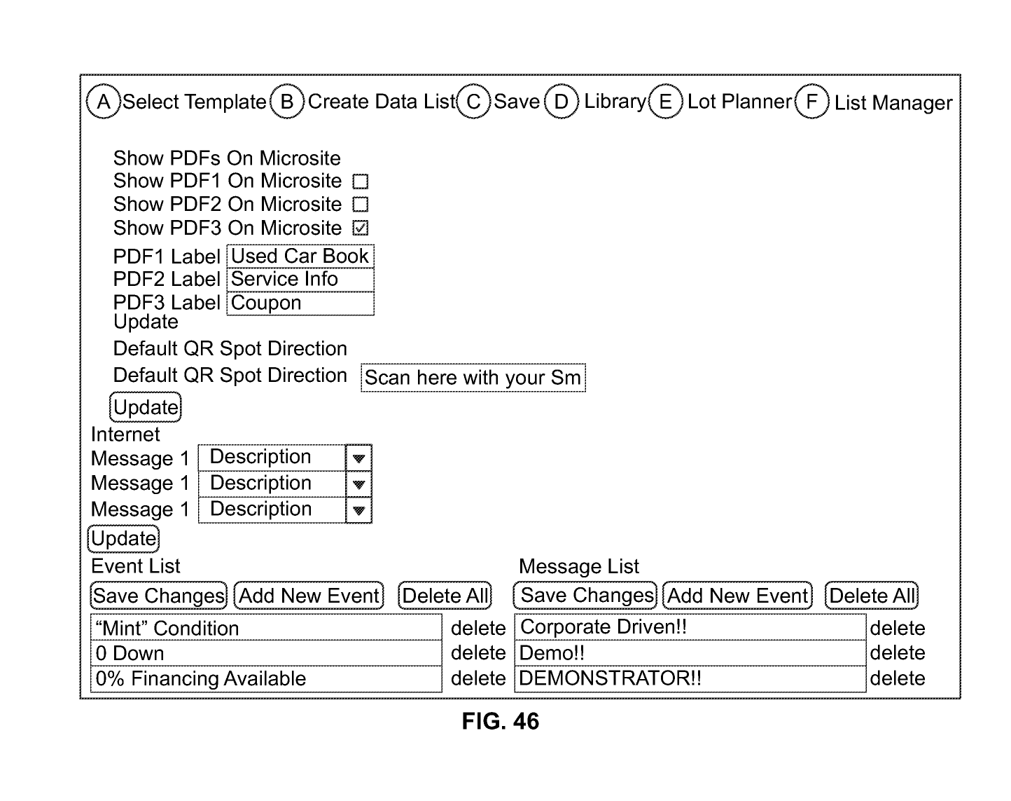

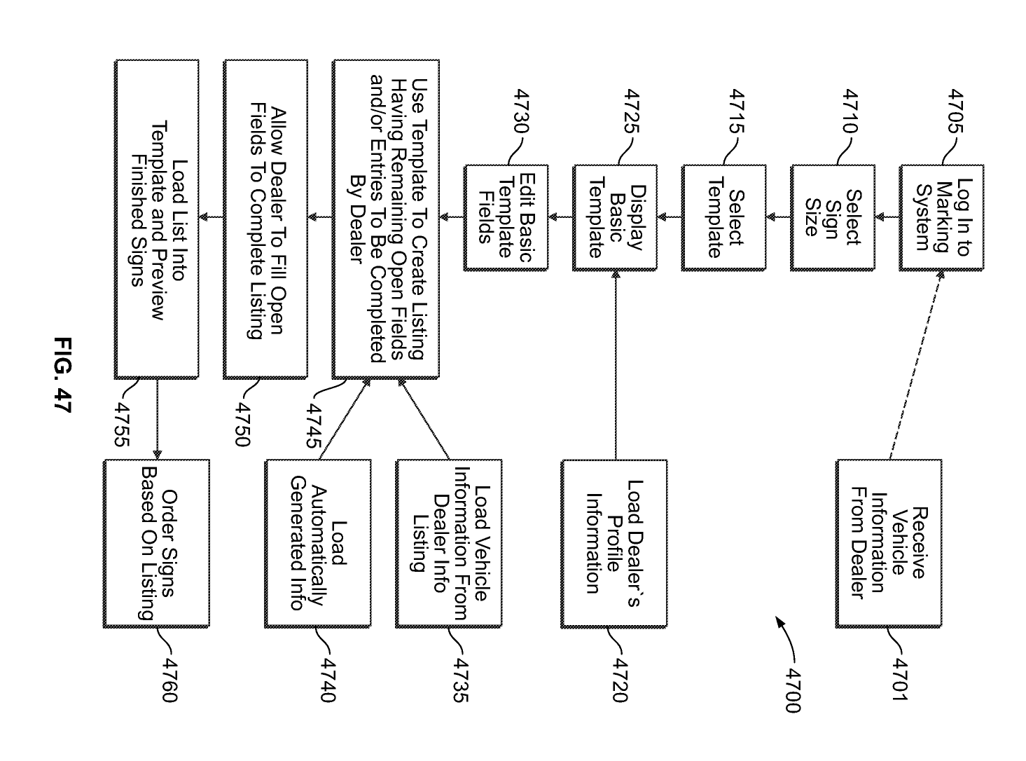

FIG. 46 illustrates further configuration options for the microsite. More specifically, the microsite may provide an alternative display in which a number of PDF files are available for download by the user. In the embodiment of FIG. 46, up to three PDF files may be displayed by the customer's device. Additionally, the buttons that appear on the customer's display may be edited by the dealer. For example, in FIG. 46, three PDFs labeled as “Used Car Book”, “Service Info”, and “Coupon” are available and the dealer has selected to include the third PDF on the microsite by checking the box next to “Show PDF3 on Microsite”.

Additionally, the configuration options allow the dealer to alter the language appears on the sign near the QR code. In FIG. 46, the language reads “Scan here with your Smartphone”, but other text strings may be entered instead.

Also, the configuration options allow the dealer to provide up to three additional dealer-configurable messages on the display. For each message, a drop down menu may be provided with options for selection or the dealer may enter text directly. In one embodiment, the drop down menu provides a menu of all terms in the description of the vehicle and allows the dealer to select one of the terms for display.

One aspect of one or more embodiments of the present invention that may be especially useful is the ability of the present marketing system to provide a dealer-selectable template that may be used to form a listing, spreadsheet and/or database composed of vehicle-standard data from the dealer combined with 1) dealer-selected or dealer-entered data that may be entered directly into the listing, and 2) automatically generated additional data such as a microsite.

FIG. 47 illustrates a flowchart 4700 reciting one embodiment of the present method in further detail. First, at step 4701, vehicle information is received from a dealer at the marketing system. The vehicle information may be received from the dealer periodically, for example, such as daily or weekly. At some point after the data has been received from the dealer, the dealer logs into the marketing system at step 4705. Next the dealer selects the sign size in step 4710 and then selects the template at step 4715.

Next, at step 4720, the dealer's profile information is loaded. The dealer's profile information may include information such as the dealer name, e-mail, web address, phone, and logo, for example.

Then, at step 4725, the basic template selected by the dealer is populated with the dealer's profile information and displayed. The dealer is then able to edit the basic template fields in step 4730.

Next, at step 4745, the basic template is used to create a listing of vehicles. The listing may include fields that are filled with vehicle information from the Origin Database server 122, (such as VIN number), may also include fields that are filled with automatically generated information (such as microsite URL address), and may include additional fields that are blank and to be filled in by the dealer (such as one or more Message fields described herein.)

The automatically generated information may be automatically generated when the vehicle information is received from the dealer. For example, when vehicle information is received from the dealer, a microsite URL address and/or a QR code may be automatically generated for each vehicle and stored at the marketing system. Alternatively, information may be automatically generated at the time that the template is used to create the listing or automatic generation may take place at both times.

At step 4750, the dealer fills the open fields to complete the listing. The additional fields that are to be filled in by the dealer may be filled in in any of several ways. For example, a global entry may be selected and then applied to each vehicle in the list. Alternatively, for a specific vehicle, the dealer may select from a drop down menu, may manually type in a text string, or may edit a previously applied global entry. The dealer may also save the composite list—the list composed of pre-filled edited and/or non-edited entries and deal entries.

Next, at step 4755, the list is loaded into the template to generate a preview of the signs. The dealer typically reviews and approved the preview and also saves the list for future reference as described herein.

Finally, at step 4760, the dealer orders the signs.

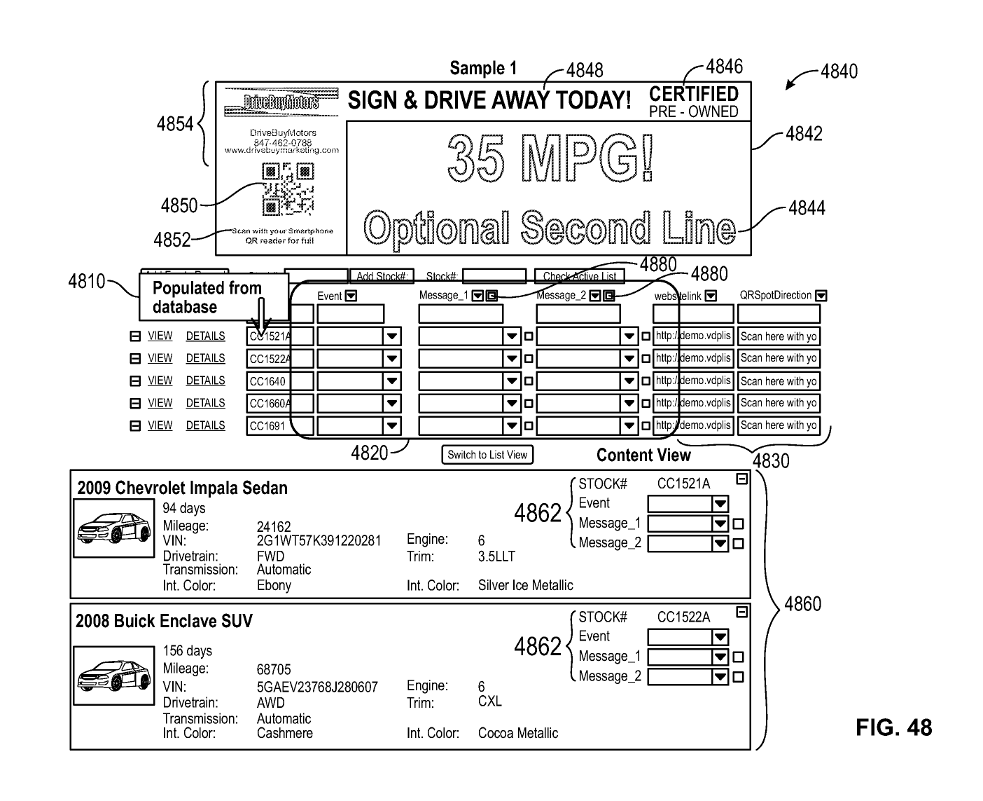

FIG. 48 illustrates an example of a featured event plus two line messaging template and associated active list. In FIG. 48, the active listing of vehicles may be seen to include information populated from a database of vehicle info 4810 which may be received from the dealer. Additionally, the active listing includes blank fields 4820 which are generated by the template for completion by the dealer. Also, the active listing includes automatically generated fields 4830 that are generated by the marketing system.

The sign 4840 may be seen to include a Message_1 line 4842, a

Message_2 line 4844, a certified pre-owned display 4846, an event message 4848, a QR code 4850 specific to that vehicle, a QRspot direction message 4852, and dealer profile information 4854,

Additionally, the information displayed in the active list may be displayed in the content view 4860. The content view 4860 also allows the dealer to enter and edit the event, Message_1 and Message_2 strings in the editing location 4862.

Also, in the active listing, check boxes 4880 allow a dealer to select from additional information for inclusion as one of the messages. For example, the downward arrow after Message_1 may allow a dealer to select from a drop down menu having a set of global standard messages. Conversely, the check box may switch the contents of the drop down menu for each vehicle to a set of information that is specific to each vehicle, such as from the description of the vehicle that is received as part of the vehicle information from the dealer. The dealer may then be presented with a drop down menu at each vehicle that allows the dealer to select vehicle-specific information for display for that vehicle.

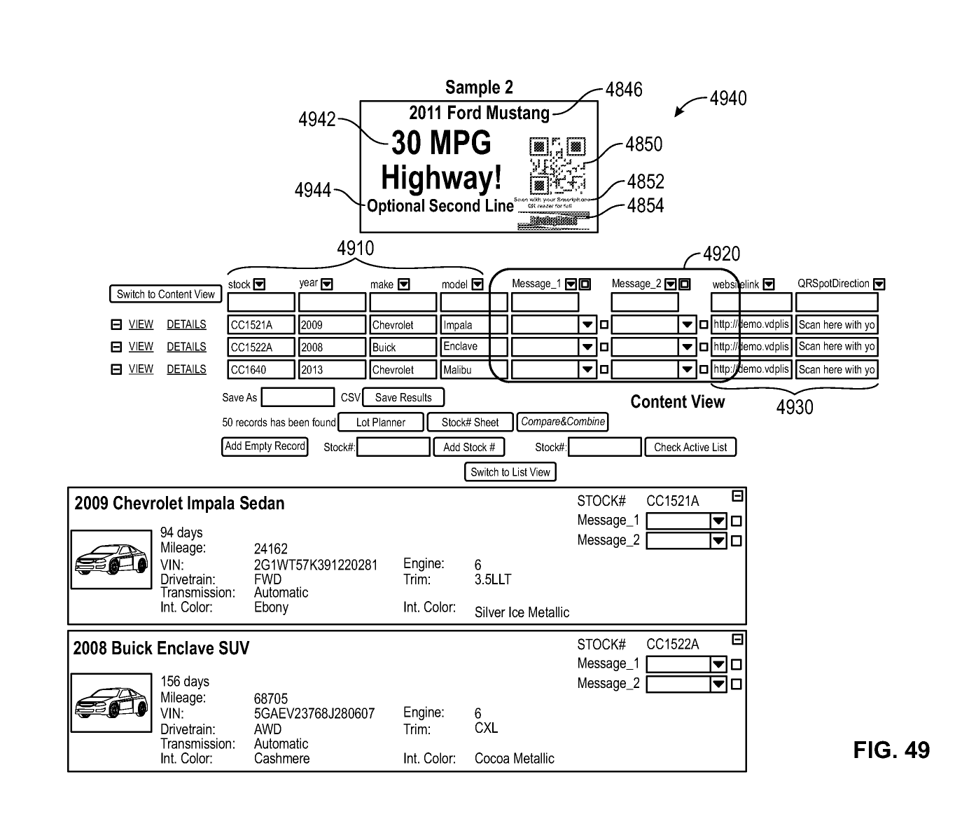

FIG. 49 illustrates an additional example of a template and associated active listing. In FIG. 49, the active listing may again be seen to include information populated from a database of vehicle info 4910 which may be received from the dealer. Additionally, the active listing includes blank fields 4920 which are generated by the template for completion by the dealer. Also, the active listing includes automatically generated fields 4930 that are generated by the marketing system.

Similar to FIG. 48, the sign 4940 may be seen to include a Message_1 line 4942, a Message_2 line 4944, the year, make, and model 4946, a QR code 4950 specific to the vehicle, a QRspot direction message 4952, and dealer profile information 4954,

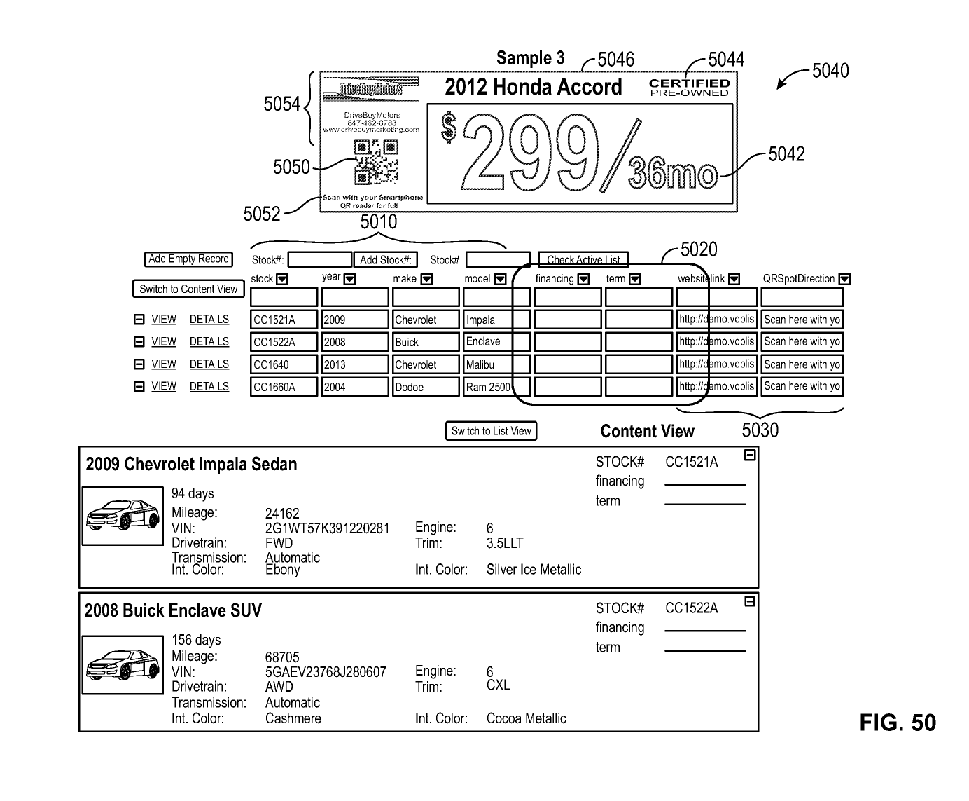

FIG. 50 illustrates an another example of a template and associated active listing. In FIG. 50, the active listing may again be seen to include information populated from a database of vehicle info 5010 which may be received from the dealer. Additionally, the active listing includes blank fields 5020 which are generated by the template for completion by the dealer. Also, the active listing includes automatically generated fields 5030 that are generated by the marketing system.

Similar to FIG. 48, the sign 5040 may be seen to include a financing cost and term 5042, a certified pre-owned indication 5044, the year, make, and model 5046, a QR code 5050 specific to the vehicle, a QRspot direction message 5052, and dealer profile information 5054.

In another embodiment, the dealer may select a template. The template may include defined columns V1-10. When the dealer then selects “create list” at the marketing system, the marketing system creates a list of populated data where columns V1-V10 data exists. The marketing system also provides a blank entry for data that is required by the template but not available in the database by creating an empty column for data entry. At this point, the marketing system may be said to have created an editable list. The editable list combines dealer edits with vehicle information to make a hybrid list to be used for final sign creation. The populated data fields are editable and the non-database fields (those fields required by the template, but now found in the vehicle information from the dealer) are also editable. Field may be edited by manual entry, the use of a pull down menu, or by selecting a global entry for the field.

Also, although one or more embodiments of the present system have been discussed with regard to the sale of cars, in an alternative embodiment the present system may be employed in the sale of other items such as houses, boats, Recreational Vehicles, motorcycles, and/or snowmobiles, for example.

Although the term “dealer” has been used extensively herein, the user of the marketing system may also be referred to as a “user” or “operator.”

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

1. A method for advertising, said method including:
receiving vehicle information for a plurality of vehicles from a dealer at a marketing system;
allowing said dealer to access said marketing system and select one of a plurality of predetermined sign sizes, wherein said sign sizes are associated with a plurality of sign templates;
allowing said dealer to select a desired template from said plurality of sign templates, wherein said desired template includes a plurality of fields;
creating a vehicle listing including entries for a plurality of vehicles, wherein said entries include said fields;
populating a subset of said fields in said vehicle listing with said vehicle information;
displaying said vehicle listing to said dealer wherein said vehicle listing includes at least one field that is blank;
allowing said dealer to enter information into said at least one field that is blank to create a sign listing; and
creating a plurality of signs based on said sign listing.

2. The method of claim 1 further including saving said sign listing at said marketing system

3. The method of claim 2 further including allowing a dealer to retrieve and edit a previously saved sign listing.

4. The method of claim 1 wherein said vehicle listing includes at least one field that that is populated with information from a dealer profile.

5. The method of claim 1 wherein said vehicle listing includes at least one field that that is populated with information that is automatically generated by said marketing system.

6. The method of claim 1 wherein said marketing system automatically generates individual microsites for a plurality of vehicles in said vehicle listing.

7. The method of claim 6 wherein said marketing system automatically generates an individual QR code for each of said microsites.

8. The method of claim 7 wherein said plurality of signs include a QR code for a microsite for an individual vehicle.

9. A method of advertising, said method including:
generating, at a marketing system, a vehicle listing for a plurality of vehicles, wherein said vehicle listing is based on one of a plurality of selectable templates that include a plurality of fields for each vehicle,
filling a first subset of said plurality of fields with vehicle information received from a dealer;
filling a second subset of said plurality of fields with information that is automatically generated;
displaying a third subset of said plurality of fields as blank entries to be filled by a user of said marketing system;
receiving information from said use to fill said fields for form a completed vehicle listing; and
printing a plurality of signs based on said one of said plurality of selectable templates and said information in said completed vehicle listing.

10. The method of claim 9 further including saving said sign listing at said marketing system

11. The method of claim 10 further including allowing a dealer to retrieve and edit a previously saved sign listing.

12. The method of claim 9 further including filling a fourth subset of said plurality of fields with information from a dealer profile.

13. The method of claim 9 wherein said filling a second subset with automatically generated information includes automatically generating individual microsites for a plurality of vehicles in said vehicle listing.

14. The method of claim 13 wherein said marketing system automatically generates an individual QR code for each of said microsites.

15. The method of claim 9 wherein said printing a plurality of signs includes printing said individual QR code for a plurality of signs.

16. An advertising system, said system including:
a marketing system receiving vehicle inventory information from a dealer,
wherein said marketing system allows a dealer to select one of a plurality of predetermined sign sizes,
wherein said sign sizes are associated with a plurality of predetermined sign templates and said dealer selects one of said templates,
wherein each template is associated with a plurality of fields;
wherein said plurality of fields includes a first subset that is filled by the marketing system with said vehicle information,
wherein said plurality of fields includes a second subset that is not fillable from said vehicle information and is displayed to said dealer for the dealer to enter information for a plurality of vehicles to form a completed vehicle list; and
a production system receiving a template selected by said dealer and said completed vehicle list and generating a plurality of signs for a plurality of vehicles based on said template and completed vehicle list.

17. The system of claim 16 wherein said plurality of fields includes a third subset that is filled by said marketing system with information that it automatically generates.

18. The system of claim 17 wherein the automatically generated information is a microsite and a QR code.

19. The system of claim 16 wherein said plurality of fields includes a fourth subset that is filled by said marketing system with information from a dealer profile;

20. The system of claim 16 wherein said completed vehicle list may be saved at said marketing system and later edited by said dealer.

21. A method for tracking inventory, said method including:
receiving, at a server at a first time, first vehicle inventory information from a dealer, wherein said first vehicle inventory information identifies a plurality of vehicles that are in the inventory of said dealer at said first time;
storing said first vehicle inventory information at said server;
receiving, at said server at a second, subsequent time, second vehicle inventory information from said dealer, wherein said second vehicle inventory information identifies a plurality of vehicles that are in the inventory of said dealer at said second time;
determining, at said server, a listing of sold vehicles, wherein said listing or sold vehicles identifies vehicles that are included in said first vehicle information, but are not included in said second vehicle information;
providing to said dealer said listing of sold vehicles.
